(19) United States
(12) Patent Application Publication
(10) Pub. No.: US 2021/0352291 A1
(43) Pub. Date: Nov. 11, 2021

(54) DETERMINING FILTER LENGTH FOR DEBLOCKING DURING ENCODING AND/OR DECODING OF VIDEO

(71) Applicant: Telefonaktiebolaget LM Ericsson (publ), Stockholm (SE)

(72) Inventors: Kenneth ANDERSSON, GÄVLE (SE); Jack ENHORN, KISTA (SE); Rickard SJÖBERG, STOCKHOLM (SE); Per WENNERSTEN, ÅRSTA (SE); Ruoyang YU, SOLNA (SE)

(21) Appl. No.: 16/330,272

(22) PCT Filed: Dec. 18, 2018
(86) PCT No.: PCT/EP2018/085357

§ 371 Date: Mar. 4, 2019

Related U.S. Application Data
(60) Provisional application No. 62/615,623, filed on Jan. 10, 2018.

(51) Int. Cl. H04N 19/132; H04N 19/117; H04N 19/82; H04N 19/105; H04N 19/159; H04N 19/176

(52) U.S. Cl. CPC H04N 19/132; H04N 19/117; H04N 19/176; H04N 19/105; H04N 19/159; H04N 19/82

(57) ABSTRACT

A method of processing a video sequence including images, wherein each image includes blocks of sample values, is provided. The method includes determining input and output lengths for deblocking filtering of sample values for a first and second side of a potential blocking boundary. The input and output lengths are consecutive sample values, from a sample value closest to the potential blocking boundary to one or more other sample values spaced from the potential blocking boundary. The input and output lengths are determined based on a number of consecutive sample values from the sample value closest to the potential blocking boundary to another sample value closest to a neighboring potential blocking boundary. The method includes deblocking filtering of the sample values on the at least one of the first and second side of the potential blocking boundary, using the input and output lengths, to generate deblocked sample values.

### TECHNICAL FIELD

The present disclosure relates generally to video processing, and more particularly, video encoding and/or decoding and related methods and devices.

### BACKGROUND

A video sequence is a series of images (also referred to as pictures) where each image includes one or more components. Each component can be described as a two-dimensional rectangular array of sample values. An image in a video sequence may include three components; one luma component Y where the sample values are luma values and two chroma components Cb and Cr, where the sample values are chroma values. The dimensions of the chroma components may be smaller than the luma components by a factor of two in each dimension. For example, the size of the luma component of a high definition HD image may be 1920×1080 and the chroma components may each have the dimension of 960×540. Components are sometimes referred to as color components.

A block is one two-dimensional array of samples (also referred to as pixels). In video coding, each component is split into blocks and the coded video bitstream is a series of blocks. In video coding, the image may be split into units that cover a specific area of the image. Each unit includes all blocks that make up that specific area and each block belongs fully to one unit. The macroblock in H.264 and the Coding unit (CU) in High Efficiency Video Coding HEVC are examples of units.

A block can be defined as a two-dimensional array that a transform used in coding is applied to. These blocks may be known as “transform blocks”. Alternatively, a block can be defined as a two-dimensional array that a single prediction mode is applied to. These blocks may be known as “prediction blocks”. In the present disclosure, the word block is not tied to one of these definitions, but descriptions herein can apply to either definition. Moreover, blocking artifacts may occur at both prediction block boundaries and transform block boundaries.

There are two types of prediction: intra prediction and inter prediction. Inter prediction predicts blocks of the current picture using blocks coming from previous decoded pictures. The previous decoded pictures that are used for prediction are referred to as reference pictures. The location of the referenced block inside the reference picture is indicated using a motion vector (MV). FIG. 1 shows an example of a MV. As shown in the example of FIG. 1, motion vector MV=(3,1), the current prediction block is C, and its best matching block in the reference picture is D.

MVs can point to fractional sample positions to better capture displacement. Those fractional samples may be generated from nearby integer samples using interpolation. In HM, MV can point to ¼th sample, and in JEM (Joint Exploratory Model), MV can point to 1/16th sample.

When encoding an inter block, the encoder may search for a best matching block from the reference pictures. The resulted MV is a hypothesis of motion of the block moving between the current picture and the reference picture.

To reduce overhead of signaling MV, there are two MV prediction tools, i.e. merge and advanced MV prediction (AMVP). Both tools use the fact that MVs inside a picture can be viewed as a stochastic process and there exist correlations among the MVs. When the current block is in merge mode, then one of its neighboring block's MV is fully reused. When the current block is in AMVP mode, then one of its neighboring blocks' MV is treated as a predictor and the resulting MV difference is explicitly signaled. The decoder follows the same MV prediction procedure to reconstruct the MV. After the MV is reconstructed, motion compensation process is invoked to derive the prediction block.

In JEM, there also exist 4×4 sub-blocks of a block that can have different motion information although no partitioning parameters are signaled, e.g. FRUC (Frame Rate Up Conversion), AFFINE, the alternative temporal motion vector prediction (ATMVP) or spatial-temporal motion vector predictor (STMVP).

A residual block includes samples that represents the sample value differences between the samples of the original source blocks and the prediction blocks. The residual block is processed using a spatial transform. The transform coefficients are then quantized according to a quantization parameter (QP) which controls the precision of the quantized coefficients. The quantized coefficients can be referred to as residual coefficients. A high QP would result in low precision of the coefficients and thus low fidelity of the residual block. A decoder then receives the residual coefficients, and applies inverse quantization and inverse transform to derive the residual block.

Local illumination compensation (LIC) is applied on the prediction block after motion compensation. It is a linear model based tool and is used for tackling local illumination change within a certain area.

FIG. 2 is a schematic diagram illustrating a reference picture and a current picture and an interaction therebetween for local illumination compensation. The current block is denoted C and the prediction block generated from its MV is D. B represents C's top and left neighboring reconstructed samples. A represents the top and left neighboring area of C's referenced block in the reference picture. LIC derives a weight(W) value and an offset(O) value by minimizing the sum of |(W*A+O)−B| for all samples in A and B. After W and O are derived, W and O are then applied on the prediction block, i.e. the modified prediction block is W*D+O.

After blocks have been reconstructed, deblocking is applied to reduce boundaries between coded blocks.

In HEVC and JEM, deblocking is first applied on vertical boundaries and then on horizontal boundaries. The boundaries are either transform block boundaries or prediction block boundaries. To enable parallel friendly deblocking, the deblocking may be performed on an 8×8 sample grid.

A deblocking filter strength parameter (bs) is set for each boundary. If the value of bs is larger than 0, then deblocking may be applied. The larger the boundary strength is, the stronger filtering is applied. First it is checked, if any of the blocks at a boundary between the blocks is an intra coded block then (bs is set to =2), or if both blocks use inter prediction and they use different reference frames or have significantly different motion vectors or if a residual is coded, then (bs is set to =1). This first check sets a boundary strength (bs) which is larger than 0 to indicate that deblocking should be applied. The larger the boundary strength is the stronger filtering is applied. To reduce/avoid removing natural structures when deblocking, a check that there are not any natural structures on respective sides of the boundary is then applied for luma. In HEVC, gradient calculations are used on respective sides of the boundary using the following inequality: d=abs(p0−2*p1+p2)+abs(q0−2*q1+q2)<beta, where beta is a parameter based on the quantization parameter for the block and p0, p1, to p2 are samples on one side of the block boundary and q0, q1, to q2 are samples on the other side of the block boundary. The condition is checked at two positions along the boundary, and if both conditions are true, then the luma samples are deblocked for that 4 sample part of the boundary. Chroma boundaries may always be filtered if any of the neighboring blocks are intra coded.

Some more details on the HEVC deblocking filter for luma as discussed below. In HEVC, a strong or weak filter decision may be determined as follows:

If dpq is less than (β>>2), Abs(p3−p0)+Abs(q0−q3) is less than (β>>3) and Abs(p0−q0) is less than (5*tC+1)>>1, the strong filter is applied. Otherwise, the weak filter is applied. HEVC strong filtering may be performed as follows:
p0′=Clip3(p0−2*tC, p0+2*tC, (p2+2*p1+2*p0+2*q0+q1+4)>>3)
p1′=Clip3(p1−2*tC, p1+2*tC, (p2+p1+p0+q0+2)>>2)
p2′=Clip3(p2−2*tC, p2+2*tC, (2*p3+3*p2+p1+p0+q0+4)>>3)
q0′=Clip3(q0−2*tC, q0+2*tC, (p1+2*p0+2*q0+2*q1+q2+4)>>3)
q1′=Clip3(q1−2*tC, q1+2*tC, (p0+q0+q1+q2+2)>>2)
q2′=Clip3(q2−2*tC, q2+2*tC, (p0+q0+q1+3*q2+2*q3+4)>>3)

In the strong filtering discussed above, p* pixels belong to block P where pixel p0 is the closest pixel to the block boundary with block Q, and q* pixels belong to block Q where q0 is closest to the block boundary with block P as shown below:
p3 p2 p1 p0 | q0 q1 q2 q3

HEVC weak filtering may be performed as follows:
Δ=(9*(q0−p0)−3*(q1−p1)+8)>>4
When Abs(Δ) is less than tC*10, the following ordered steps apply:
The filtered sample values p0′ and q0′ are specified as follows:
Δ=Clip3(−tC, tC, Δ)
p0′=Clip1Y(p0+Δ)
q0′=Clip1Y(q0−Δ)

When dp is less than (β+(β>>1))>>3, the variable dEp is set equal to 1.

When dq is less than (β+(β>>1))>>3, the variable dEq is set equal to 1.
When dEp is equal to 1, the filtered sample value p1′ is specified as follows:
Δp=Clip3(−(tC>>1), tC>>1, (((p2+p0+1)>>1)−p1+Δ)>>1)
p1′=Clip1Y(p1+Δp)
When dEq is equal to 1, the filtered sample value q1′ is specified as follows:
Δq=Clip3(−(tC>>1), tC>>1, (((q2+q0+1)>>1)−q1−Δ)>>1)
q1′=Clip1Y(q1+Δq)

Although some blocks (CUs) may have internal edges due to different prediction parameters in 4×4 sub-blocks those internal edges are not deblocked in JEM.

Another problem is that deblocking on a four pixel grid can result in recursive filtering for luma since the strong filter in JEM uses 4 pixels on each side of the boundary as part of deblocking 3 pixels on each side of the block boundary.

The problem of recursive filtering may be reduced in the operations by restricting the deblocking on transform and prediction boundaries that overlap an 8×8 grid as in HEVC. However, that approach is unacceptable because it would maximally allow for deblocking filtering using 4 samples on respective side of such boundaries. Additionally, that would not remedy blocking artifacts that occur at any multiple of 4 inside the current block.

### SUMMARY

Some embodiments disclosed herein are directed to determining filter length for deblocking during encoding and/or decoding of video. A method of processing a video sequence including a plurality of images is provided. Each image of the plurality of images includes a plurality of blocks of sample values. The method includes determining an input length and an output length for deblocking filtering of the sample values for respectively a first side and a second side of a potential blocking boundary. The input length and the output length can be different and are a number of consecutive sample values, from a sample value that is closest to the potential blocking boundary to one or more other sample values spaced from the potential blocking boundary. According to some embodiments, the input length and the output length are determined based on determining a number of consecutive sample values from the sample value closest to the potential blocking boundary to another sample value closest to a neighboring potential blocking boundary. The method further includes performing deblocking filtering of the sample values on the at least one of the first side and the second side of the potential blocking boundary, using the input length and the output length that are determined, to generate deblocked sample values.

The method may provide a potential advantage of reducing occurrence of discontinuities and providing deblocking filtering while avoiding undesirable recursive operations and avoiding over-smoothing of the natural texture of an image. One importance of avoiding recursive operations is that deblocking filtering of video data may be performed by processors that are operating in parallel. Further, such operations may allow for the use of a longer filter, which may be beneficial when larger blocks are used.

In some other embodiments, an electronic device is provided. The electronic device is configured to perform operations that include determining an input length and an output length for deblocking filtering of the sample values on respectively a first side and a second side of a potential blocking boundary. The input length and the output length can be different and are a number of consecutive sample values from a sample value that is closest to the potential blocking boundary to one or more other sample values spaced from the potential blocking boundary. The input length and the output length are determined based on a number of consecutive sample values from the sample value closest to the potential blocking boundary to another sample value closest to a neighboring potential blocking boundary. The operations further include performing deblocking filtering of the sample values on the at least one of the first side and the second side of the potential blocking boundary, using the input length and the output length that are determined, to generate deblocked sample values.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating a reference picture, a current picture, and a motion vector MV used to predict a block;

FIG. 2 is a schematic diagram illustrating a reference picture and a current picture and an interaction therebetween for local illumination compensation;

FIG. 3 illustrates a current potential boundary, a neighboring potential boundary, and the result of operations according to an embodiment of the present disclosure for determining the input and output length for deblocking filtering;

FIG. 4 illustrates operations for using neighboring input and output length on a first and second side of the current potential blocking boundary in accordance with another embodiment;

FIG. 5 is a block diagram illustrating an electronic device according to some embodiments of inventive concepts;

FIG. 6 is a block diagram illustrating encoder operations according to some embodiments of inventive concepts;

FIG. 7 is a block diagram illustrating decoder operations according to some embodiments of inventive concepts;

FIG. 8 illustrates potential vertical blocking boundaries of a current block;

FIG. 9 illustrates block and sub-block boundaries from prediction and transforming blocks;

FIG. 10 illustrates operations that control input and output deblocking filter length for a current potential blocking boundary;

FIG. 11 is a flowchart of operations for processing a video sequence in accordance with some embodiments;

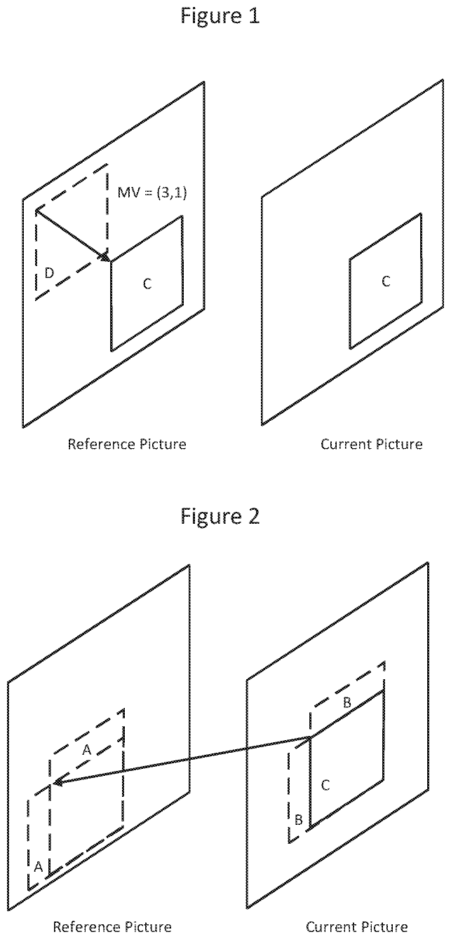

FIG. QQ1 is a block diagram of a wireless network in accordance with some embodiments;

FIG. QQ2 is a block diagram of a user equipment in accordance with some embodiments

FIG. QQ3 is a block diagram of a virtualization environment in accordance with some embodiments;

FIG. QQ4 is a block diagram of a telecommunication network connected via an intermediate network to a host computer in accordance with some embodiments;

FIG. QQ5 is a block diagram of a host computer communicating via a base station with a user equipment over a partially wireless connection in accordance with some embodiments;

FIG. QQ6 is a block diagram of methods implemented in a communication system including a host computer, a base station and a user equipment in accordance with some embodiments;

FIG. QQ7 is a block diagram of methods implemented in a communication system including a host computer, a base station and a user equipment in accordance with some embodiments;

FIG. QQ8 is a block diagram of methods implemented in a communication system including a host computer, a base station and a user equipment in accordance with some embodiments; and

FIG. QQ9 is a block diagram of methods implemented in a communication system including a host computer, a base station and a user equipment in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

### Electronic Devices, Encoders, and Decoders

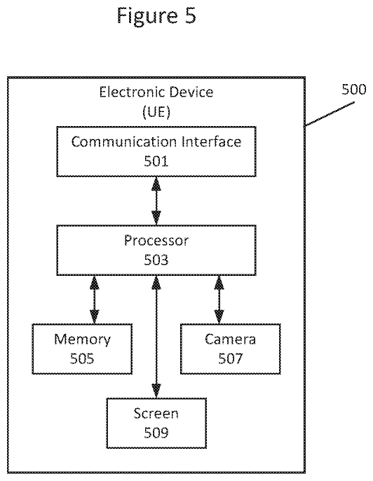

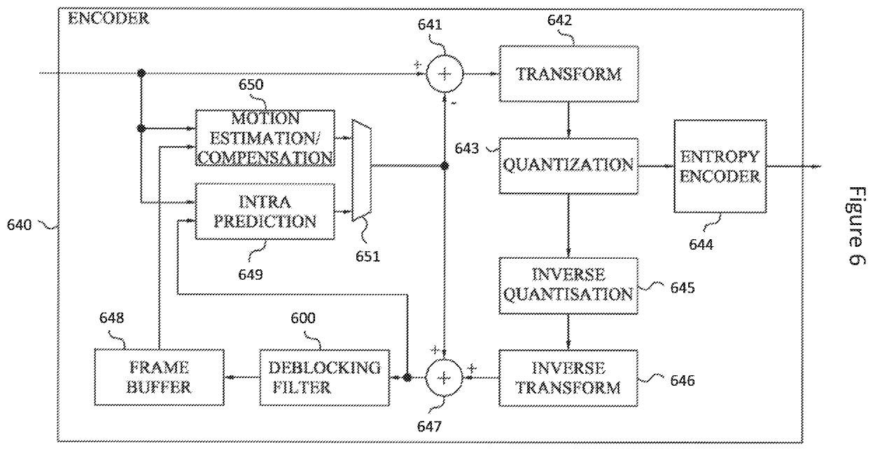

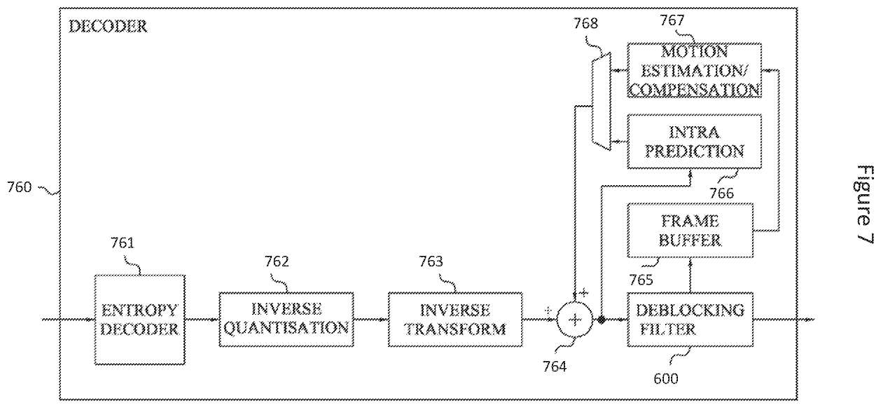

FIG. 5 is a block diagram illustrating an electronic device 500 (which may be a wireless device, a 3GPP user equipment or UE device, etc.) according to some embodiments disclosed herein. As shown, electronic device 500 may include processor 503 coupled with communication interface 501, memory 505, camera 507, and screen 509. Communication interface 501 may include one or more of a wired network interface (e.g., an Ethernet interface), a WiFi interface, a cellular radio access network (RAN) interface (also referred to as a RAN transceiver), and/or other wired/wireless network communication interfaces. Electronic device 500 can thus provide wired/wireless communication over one or more wire/radio links with a remote storage system to transmit and/or receive an encoded video sequence. Processor 503 (also referred to as a processor circuit or processing circuitry) may include one or more data processing circuits, such as a general purpose and/or special purpose processor (e.g., microprocessor and/or digital signal processor). Processor 503 may be configured to execute computer program instructions from functional modules in memory 505 (also referred to as a memory circuit or memory circuitry), described below as a computer readable medium, to perform some or all of the operations and methods that are described herein for one or more of the embodiments. Moreover, processor 503 may be defined to include memory so that separate memory 505 may not be required. Electronic device 500 including, communication interface 501, processor 503, and/or camera 507 may thus perform operations, for example, discussed below with respect to the figures and/or Example Embodiments.

According to some embodiments, electronic device 500 (e.g., a smartphone) may generate an encoded video sequence that is either stored in memory 505 and/or transmitted through communication interface 501 over a wired network and/or wireless network to a remoted device. In such embodiments, processor 503 may receive a video sequence from camera 509, and processor may encode the video sequence to provide the encoded video sequence that may be stored in memory 505 and/or transmitted through communication interface 501 to a remote device.

According to some other embodiments, electronic device 500 may decode an encoded video sequence to provide a decoded video sequence that is rendered on display 509 for a user to view. The encoded video sequence may be received from a remote communication device through communication interface 501 and stored in memory 505 before decoding and rendering by processor 503, or the encoded video sequence may be generated by processor 503 responsive to a video sequence received from camera 507 and stored in memory 505 before decoding and rendering by processor 503. Accordingly, the same device may thus encode a video sequence and then decode the video sequence.

Operations of encoding and decoding performed by processor 503 will now be discussed with reference to FIGS. 6 and 7. Modules (also referred to as units) may be stored in memory 505 of FIG. 5, and these modules may provide instructions so that when the instructions of a module are executed by processor 503, processor 503 performs respective operations according to any one or more of the embodiments disclosed herein.

FIG. 6 is a schematic block diagram of an encoder 640 which may be implemented by processor 503 to encode a block of pixels in a video image (also referred to as a frame) of a video sequence according to some embodiments of inventive concepts.

A current block of pixels is predicted by performing a motion estimation using motion estimator 650 from an already provided block of pixels in a previous frame. The result of the motion estimation is a motion or displacement vector associated with the reference block, in the case of inter prediction. The motion vector may be used by motion compensator 650 to output an inter prediction of the block of pixels.

Intra predictor 649 computes an intra prediction of the current block of pixels from already provided pixels in the same frame. The outputs from the motion estimator/compensator 650 and the intra predictor 649 are input in selector 651 that either selects intra prediction or inter prediction for the current block of pixels. The output from the selector 651 is input to an error calculator in the form of adder 641 that also receives the pixel values of the current block of pixels. Adder 641 calculates and outputs a residual error as the difference in pixel values between the block of pixels and its prediction.

The error is transformed in transformer 642, such as by a discrete cosine transform, and quantized by quantizer 643 followed by coding in encoder 644, such as by entropy encoder. In inter coding, also the estimated motion vector is brought to encoder 644 to generate the coded representation of the current block of pixels.

The transformed and quantized residual error for the current block of pixels is also provided to an inverse quantizer 645 and inverse transformer 646 to retrieve the original residual error. This error is added by adder 647 to the block prediction output from the motion compensator 650 or intra predictor 649 to create a reconstructed block of pixels that can be used for reference in the prediction and coding of a next block of pixels. This new reconstructed is first processed by a deblocking filter 600 according to examples/embodiments discussed below to perform deblocking filtering to reduce/combat blocking artifacts. The processed new reconstructed block is then temporarily stored in frame buffer 648, where it is available to intra predictor 649 and motion estimator/compensator 650.

FIG. 7 is a corresponding schematic block diagram of decoder 760 including deblocking filter 600 which may be implemented by processor 503 according to some embodiments of inventive concepts. Decoder 760 includes decoder 761, such as entropy decoder, to decode an encoded representation of a block of pixels to get a set of quantized and transformed residual errors. These residual errors are dequantized by inverse quantizer 762 and inverse transformed by inverse transformer 763 to provide a set of residual errors.

These residual errors are added by adder 764 to the pixel values of a reference block of pixels. The reference block is determined by a motion estimator/compensator 767 or intra predictor 766, depending on whether inter or intra prediction is performed. Selector 768 is thereby interconnected to adder 764 and motion estimator/compensator 767 and intra predictor 766. The resulting decoded block of pixels output form adder 764 is input to deblocking filter 600 according to some embodiments of inventive concepts to provide deblocking filtering of blocking artifacts. The filtered block of pixels is output from decoder 760 and may be furthermore temporarily provided to frame buffer 765 to be used as a reference block of pixels for a subsequent block of pixels to be decoded. Frame buffer 765 is thereby connected to motion estimator/compensator 767 to make the stored blocks of pixels available to motion estimator/compensator 767.

The output from adder 764 may also be input to intra predictor 766 to be used as an unfiltered reference block of pixels.

In embodiments of FIGS. 6 and 7, deblocking filter 600 may perform deblocking filtering as so called in-loop filtering. In alternative embodiments at decoder 760, deblocking filter 600 may be arranged to perform so called post-processing filtering. In such a case, deblocking filter 600 operates on the output frames outside of the loop formed by adder 764, frame buffer 765, intra predictor 766, motion estimator/compensator 767, and selector 768. In such embodiments, no deblocking filtering is typically done at the encoder. Operations of deblocking filter 600 will be discussed in greater detail below.

### Deblocking Filter Length Determination

Various embodiments of the inventive concepts are directed to determining the input and output length for deblocking filtering for a first and a second side of a current potential blocking boundary. A potential blocking boundary corresponds to a discontinuity between sample values along the boundary of a first block (first side) and sample values along the block boundary of a second block (second side) that either will be deblocked or likely will be deblocked by deblocking filtering. For example if deblocking is performed on transform and prediction boundaries that are aligned with an 8×8 grid a potential deblocking boundary cannot happen on a boundary that not is aligned with the 8×8 grid. For example if deblocking is performed on transform and prediction boundaries that are aligned with an 4×4 grid a potential deblocking boundary cannot happen on a boundary that not is aligned with the 4×4 grid.

Input length for a first or a second side of the current potential blocking boundary refers to the distance in samples from and including the sample closest to the current potential blocking boundary on a first or a second side to the sample furthest away from the boundary on a first or a second side of the current potential blocking boundary that is read by deblocking filtering. Output length for a first or a second side of the current potential blocking boundary refers to the number of consecutive samples from and including the sample closest to the current potential blocking boundary on a first or a second side to the sample furthest away from the boundary on the first or the second side of the current potential blocking boundary that are modified by deblocking filtering. Accordingly, the input length and the output lengths can be different and are each defined as a number of consecutive samples values from a sample value that is closest to the potential blocking boundary to another sample value (either the same other sample value or respectively different other sample values) away from the potential blocking boundary.

The input length and the output length for a first side and/or a second side of the current potential blocking boundary can be determined based on at least one of the following:

1. The existence of a discontinuity between at least one sample on the first side and one sample on the second side both adjacent to the current potential blocking boundary.

2. The number of consecutive smooth samples perpendicular to the potential blocking boundary on the first and the second side respectively.

3. The number of consecutive lines along the current potential blocking boundary that both conform to the above two conditions.

4. The width and height of the block on the first side and the width and height of the block on the second side.

5. Whether the current potential blocking boundary is an internal sub-block boundary or not.

6. Distance to a neighboring potential blocking boundary, i.e., a number of consecutive samples values from the sample value closest to the potential blocking boundary to another sample value closest to a neighboring potential blocking boundary.

Deblocking filtering is then applied for at least one side of the current potential blocking boundary using the input and output length that was determined for that side of the boundary.

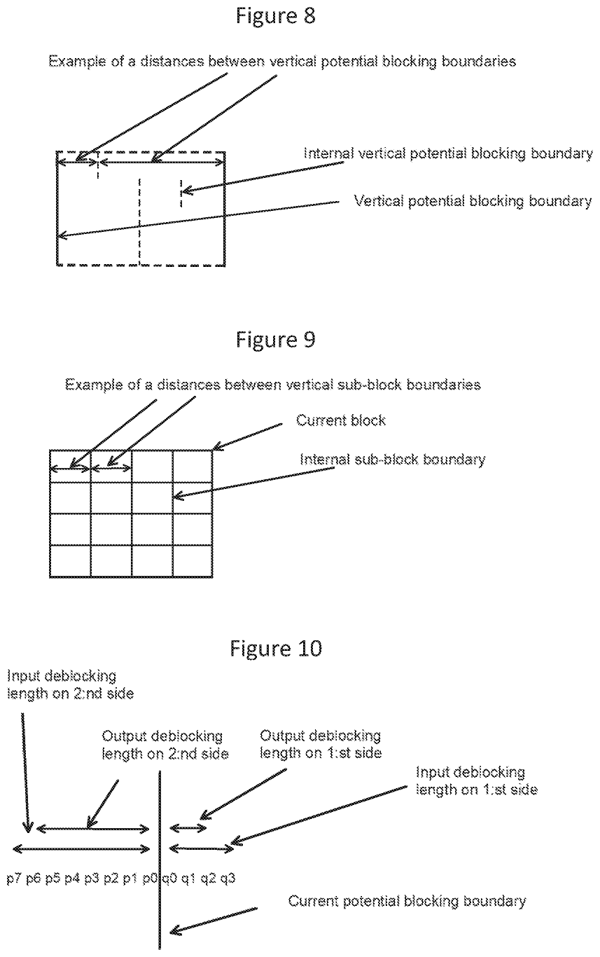

FIG. 8 illustrates potential vertical blocking boundaries of a current block. A vertical potential blocking boundary can correspond to a coding unit block, prediction block or transform block and an internal vertical potential blocking boundary can correspond to prediction block or transform block inside the coding unit block.

FIG. 9 illustrates block and sub-block boundaries from prediction and transform blocks.

FIG. 10 illustrates operations that control input and output deblocking filter length for a current potential blocking boundary.

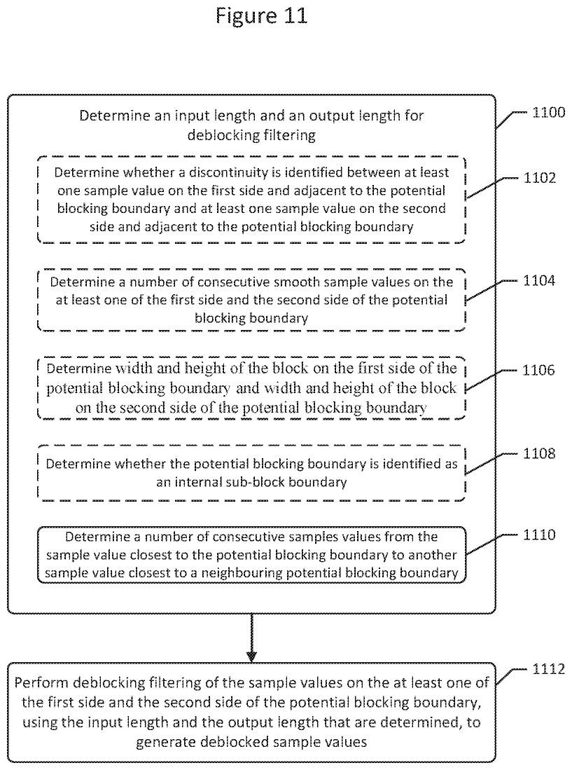

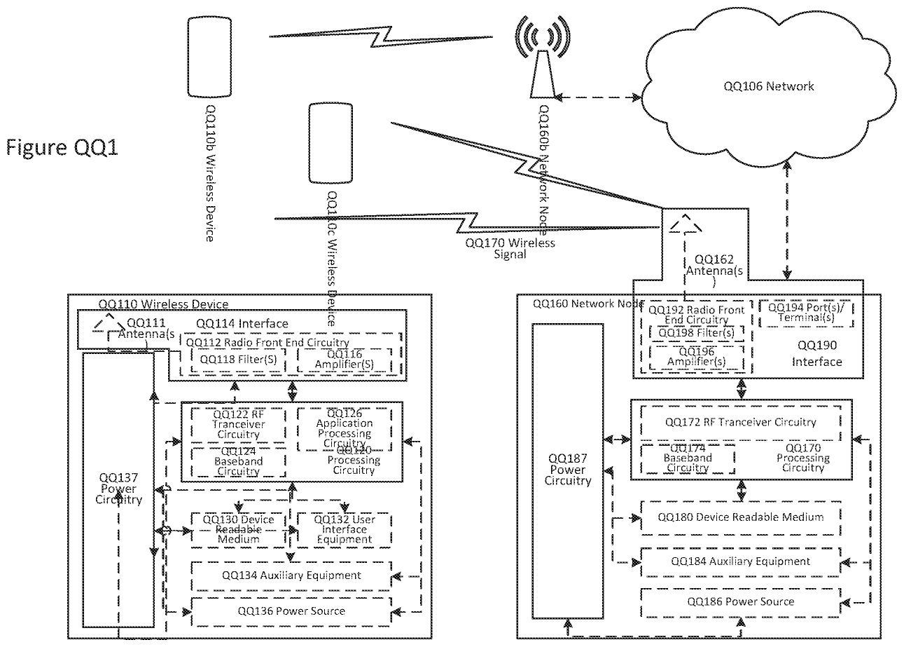

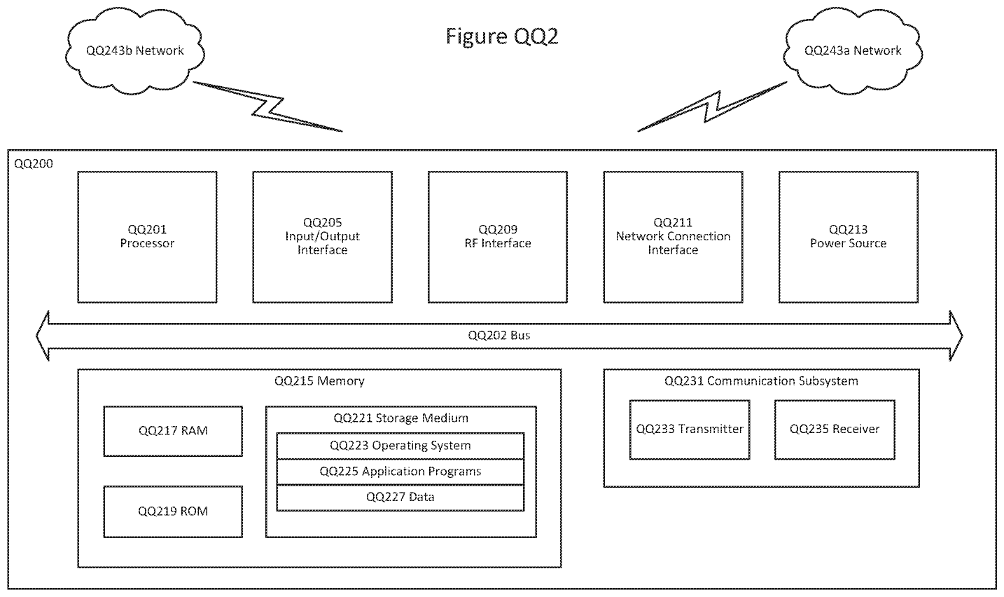

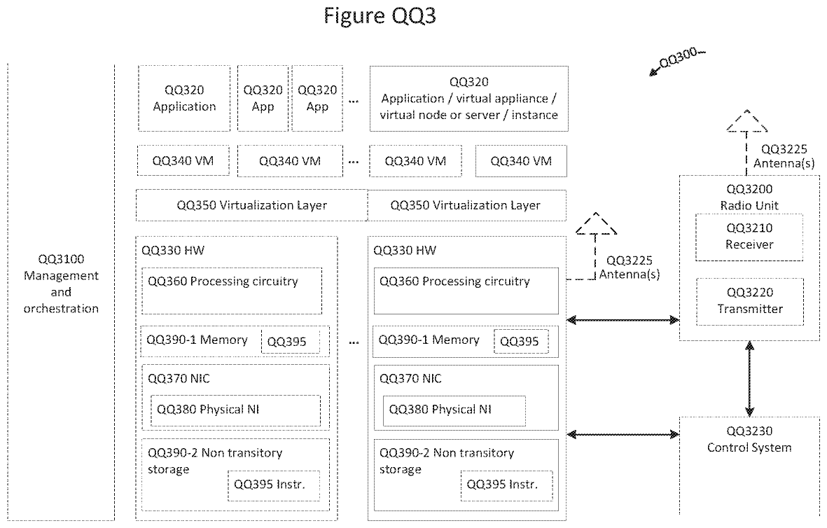

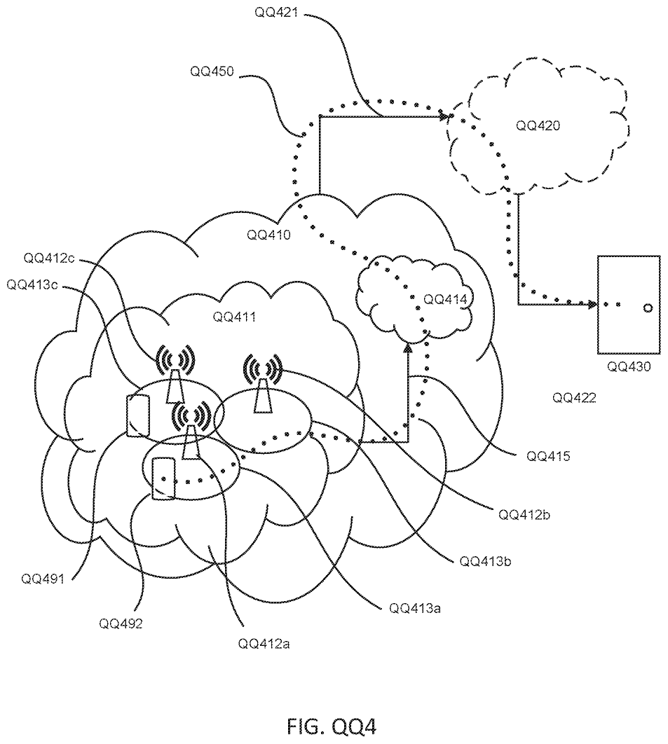

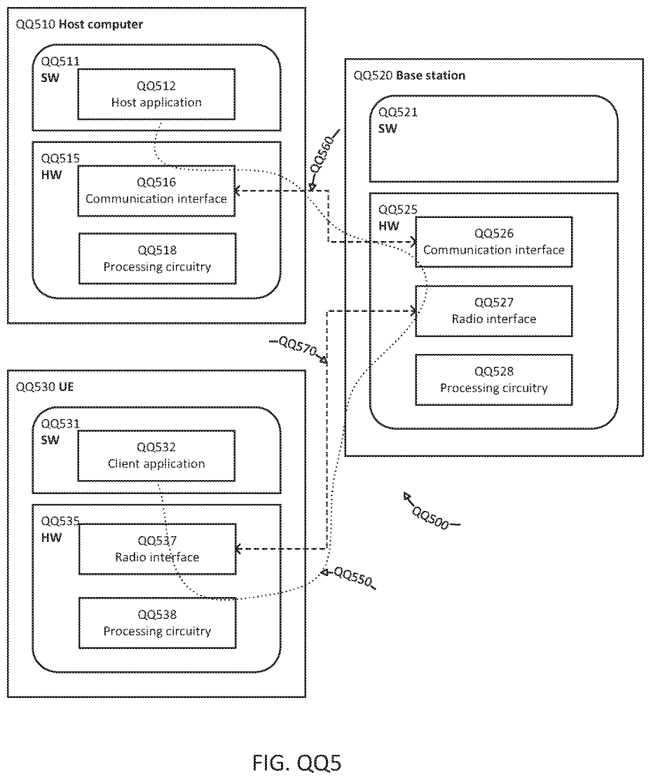

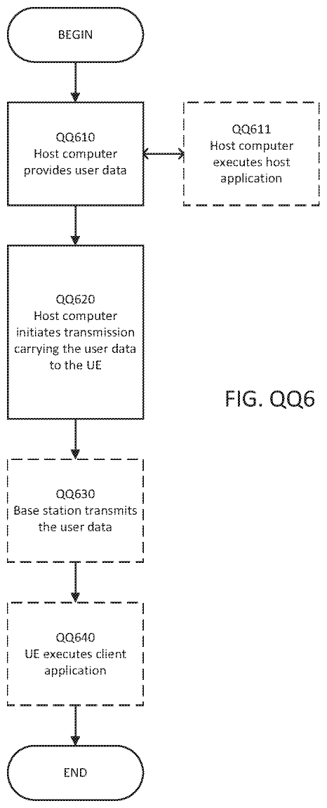

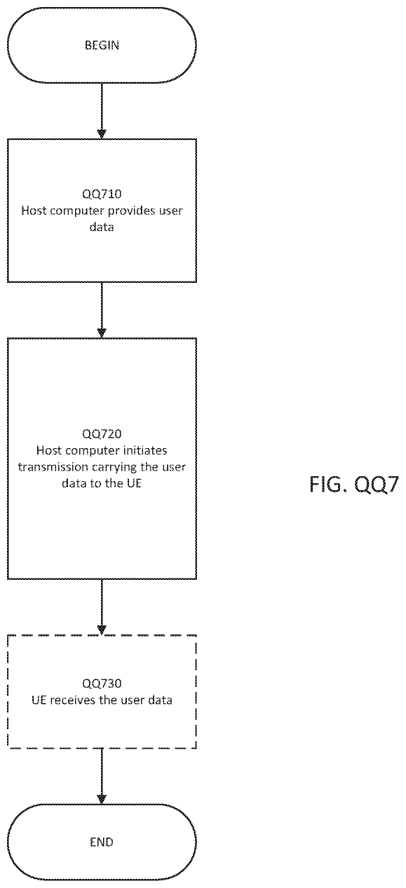

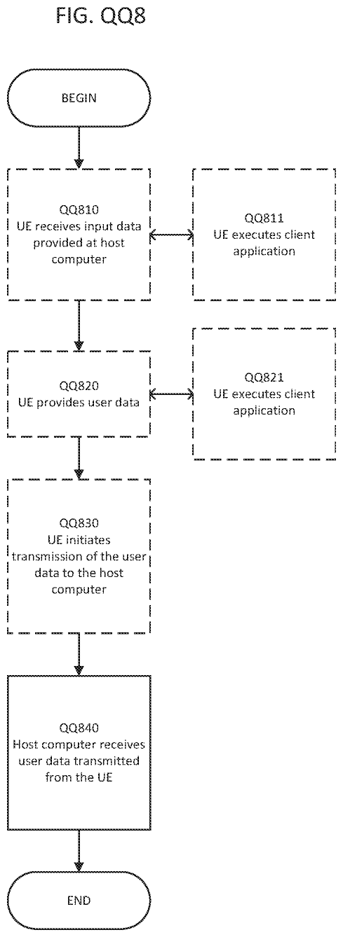

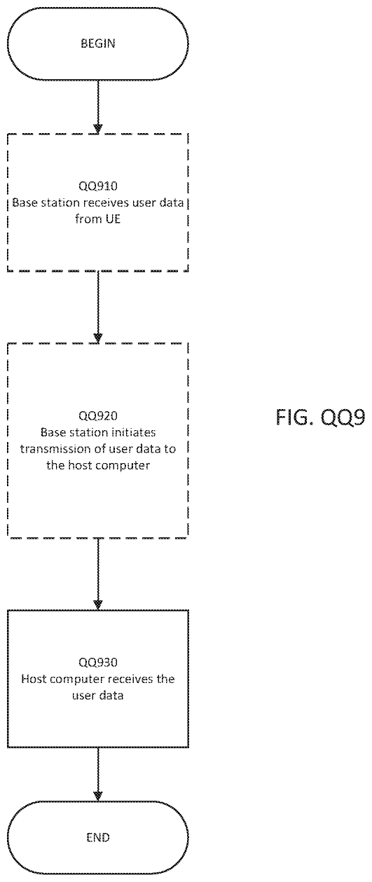

FIG. 11 is a flowchart of operations for processing a video sequence that includes a plurality of images, with each image of the plurality of images including a plurality of blocks of sample values. Referring to FIG. 11, the operations include determining (1100) an input length and an output length for deblocking filtering of the sample values on respectively a first side and a second side of a potential blocking boundary. The input length and the output lengths can be different and are a number of consecutive samples values from a sample value that is closest to the potential blocking boundary to one or more other sample values spaced from the potential blocking boundary. The input length is at least one sample on respective side of the potential blocking boundary and the output length is at least non-zero for one side of the potential blocking boundary.

The input length and the output length are determined based on at least one of:

determining (1102) whether a discontinuity is identified between at least one sample value on the first side and adjacent to the potential blocking boundary and at least one sample value on the second side and adjacent to the potential blocking boundary, where the determination may determine whether the discontinuity is less than a defined threshold value;

determining (1104) a number of consecutive smooth sample values on the at least one of the first side and the second side of the potential blocking boundary;

determining (1106) width and height of the block on the first side of the potential blocking boundary and width and height of the block on the second side of the potential blocking boundary;

determining (1108) whether the potential blocking boundary is identified as an internal sub-block boundary; and

determining (1110) a number of consecutive samples values from the sample value closest to the potential blocking boundary to another sample value closest to a neighboring potential blocking boundary.

The input length can include is at least one sample on a respective side of the potential blocking boundary, and the output length can be at least non-zero for one side of the potential blocking boundary.

Deblocking filtering of the sample values on the at least one of the first side and the second side of the potential blocking boundary is then performed (1112) using the input length and the output length that are determined, to generate deblocked sample values.

The output length that is determined for deblocking filtering may be restricted to not being greater than the input length that is determined for deblocking filtering.

A decoded video sequence can be generated including a decoded image containing the deblocked sample values. Alternatively or additionally, an encoded video sequence can be generated based on the deblocked sample values.

In some embodiments, the input length and the output length for deblocking filtering of one of the plurality of blocks are determined (1100) to be longer responsive to the potential blocking boundary coinciding with a block boundary of one of the plurality of blocks and are determined to be shorter responsive to the potential blocking boundary not coinciding with the block boundary of the one of the plurality of blocks.

In other embodiments, the potential blocking boundary corresponds to a discontinuity between sample values along a boundary of a first block and sample values along a boundary of a second block, wherein the deblocking filtering is performed to deblock the potential blocking boundary.

In additional embodiments, a high efficiency video coding (HEVC) weak deblocking filter is used to deblock at least one sample.

### Potential Advantages

The operations disclosed herein for determining deblocking filter length can reduce discontinuities across both block and internal sub-block boundaries, and still enable deblocking filtering without undesirable recursive operations and without over smoothing natural texture. Avoiding recursive operations allows the deblocking filtering of video data to be performing in parallel processors. The operations disclosed herein may allow for use of a longer filter which is subjectively beneficial when larger blocks are used.

### Example Embodiments for Determining Deblocking Filter Lengths

Embodiments disclosed herein may be performed by an encoder and/or a decoder for reducing discontinuities between blocks and sub-blocks. The filter coefficients that are used for deblocking filter can be determined as needed for a particular encoder and/or decoder application. The present embodiments provide operational conditions that are used for determining the input and output lengths for deblocking filtering using such filter coefficients.

A potential blocking boundary can be identified as a boundary when at least one of the following characteristics is satisfied:

1. At least one side of the boundary is intra predicted.

2. There is a difference in prediction parameters on respective side of the boundary, such as motion vector, reference picture, LIC parameters, weighted prediction parameters, scaling or offset in motion compensated prediction.

3. There is a difference in residual parameters on respective side of the boundary, such as the one side belongs to one transform block and the other side belongs to another transform block where at least one of the side has non-zero residual parameters, e.g. transform coefficients.

4. It is a boundary of a transform block or a prediction block.

At least one of following additional criterions that may need to be true for identification of a potential blocking boundary are:

1. Blocking artifact detected, e.g. absolute pixel difference from pixels from respective side of the boundary larger than 0.

2. Blocking artifact detected but absolute pixel difference from respective side of the boundary is less than a threshold based on QP, to avoid determining potential blocking boundary that actually correspond to natural variations.

3. Existence of smooth samples on at least one side of the block boundary.

In some embodiments, a potential blocking boundary can be identified as a boundary when at least one of the following characteristics is satisfied: at least one side of the potential blocking boundary is intra predicted; a difference exists between prediction parameters on each respective side of the potential blocking boundary, wherein prediction parameters comprise at least one of a motion vector, a reference picture, a local illumination compensation, LIC, parameter, a weighted prediction parameter, scaling, and/or an offset in motion-compensated prediction; a difference exists between residual parameters on each respective side of the potential blocking boundary, wherein a difference in residual parameters comprises one side of the potential blocking boundary belonging to one transform block and another side of the potential blocking boundary belonging to another transform block, wherein at least the one of the sides has non-zero residual parameters; and/or the potential blocking boundary is a boundary of a transform block and/or a prediction block.

### Embodiment 1

The input and output length for deblocking filtering of a first side of the current potential blocking boundary is determined based on the distance between the current potential blocking boundary and the closest neighboring potential blocking boundary on the first side. The input and output length for deblocking filtering of a second side of the current potential blocking boundary is determined based on the distance between the current potential blocking boundary and the closest neighboring potential blocking boundary on the second side.

Thus, the operations can include determining the input length and the output length for deblocking filtering based on a number of consecutive samples values from the sample value closest to the potential blocking boundary to another sample value closest to a closest neighboring potential blocking boundary. In some embodiments, the input length is set to 2 sample values and the output length is set to 1 sample value when the number of consecutive sample values is 4.

Input length for a first or a second side of the current potential blocking boundary refers to the distance in samples from and including the sample closest to the current potential blocking boundary on a first or a second side to the sample furthest away from the boundary on a first or a second side of the current potential blocking boundary that is read by deblocking filtering. Output length for a first or a second side of the current potential blocking boundary refers to the number of consecutive samples from and including the sample closest to the current potential blocking boundary on a first or a second side to the sample furthest away from the boundary on the first or the second side of the current potential blocking boundary that are modified by deblocking filtering. Typically, the output length is shorter than the input length of deblocking filtering.

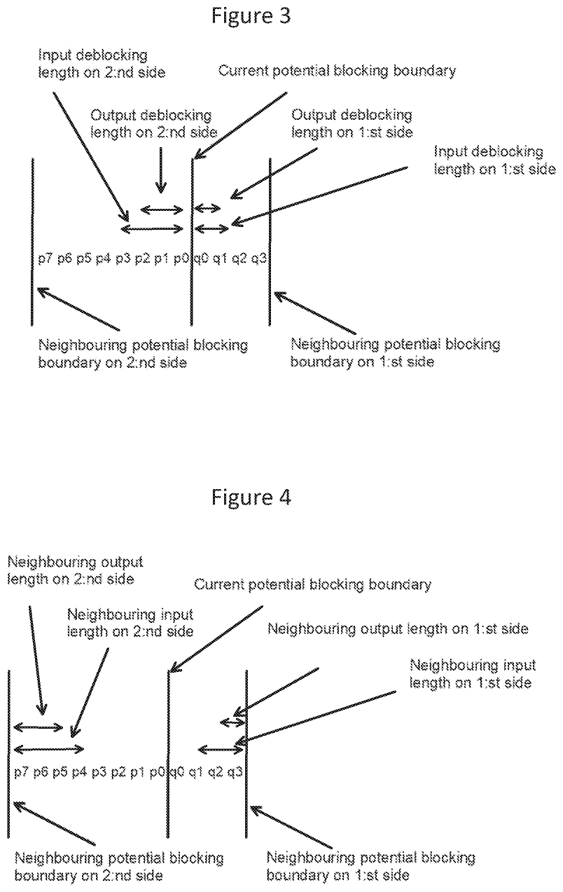

FIG. 3 illustrates a current potential boundary, a neighboring potential boundary, and the result of operations according to Embodiment 1 for determining the input and output length for deblocking filtering of a first and second side of the current potential blocking boundary.

In this embodiment, the input length of deblocking filtering is determined to be equal to half of the distance between the current potential blocking boundary and the neighbouring potential blocking boundary in that direction. The output length for deblocking filtering can in this case either be identical to the input length or at least one sample shorter. For example, if the distance from the current potential blocking boundary to the neighboring potential blocking boundary on a first side of the current blocking boundary is 4 samples and the distance from the current potential blocking boundary to the neighboring potential blocking boundary on a second side of the current potential blocking boundary is 8 samples, the input length of deblocking filtering for the first side is set to 2 samples and the input length of deblocking filtering for the second side is set to 4 samples.

In a variant of this embodiment, that also avoids recursive filtering and enables parallel deblocking filtering as the above embodiment, the input length of deblocking filtering is determined such that it only covers samples that are not modified by deblocking of the neighboring potential blocking boundary. The output length for deblocking filtering can in this case either be identical to the input length or at least one sample shorter. FIG. 4 illustrates operations for using neighboring input and output length on a first and second side of the current potential blocking boundary.

According to some embodiments, the input length is determined to be equal to half of the distance between the current potential blocking boundary and the neighbouring potential blocking boundary, and wherein the input length only covers samples that are not modified by deblocking of the neighboring potential blocking boundary.

With reference to FIG. 4, when the neighboring deblocking filter on a first side has an input length of 3 samples and an output length of 1 samples in a direction towards the current potential blocking boundary the input length for deblocking filtering of the current boundary on the first side is determined to be the distance between the current potential blocking boundary and the neighboring potential blocking boundary on the first side minus the output length for the neighbor deblocking filter.

For example, when the distance is 4 the input length for deblocking of the first side of the current boundary is 4 minus 1 is equal to 3. The output length is the distance minus the input length for the neighboring deblocking filter, e.g. 4 minus 3 equal to 1. Similarly, when the neighboring deblocking filter on the second side has an input length of 4 samples and an output length of 3 sample towards the current potential blocking boundary the input length for deblocking filtering of the current boundary on the second side is determined to be the distance between the current potential blocking boundary and the neighboring potential blocking boundary on the second side minus the output length for the neighboring deblocking filter. In a further example, when the distance is 8 the input length for deblocking of the second side of the current boundary is 8 minus 3 equal to 5. The output length for the deblocking of the second side of the current boundary is the distance minus the input length of the neighboring deblocking on the second side, e.g. 8 minus 4 equal to 4 in this case.

Further illustrative examples are provided below where “|” indicates a neighbouring boundary, “∥” indicates current boundary, “n” indicates a sample output by deblocking of a neighboring blocking boundary, “i” corresponds to a sample that only is used as input for deblocking but is not output by any deblocking, and “c” corresponds to samples that are output by deblocking of the current potential blocking boundary. The first side is to the right of current boundary and the second side is to the left of the current boundary.
   | n n n i c c c c ∥ c i i n |

### Embodiment 2

Embodiment 2 is similar to Embodiment 1, however the input and output deblocking filtering length is set to be same for both sides of the current potential blocking boundary.

Thus, the operations determine a same value for the input length for deblocking filtering for the first and second sides of the potential blocking boundary, and determine a same value for the output length for deblocking filtering for the first and second sides of the potential blocking boundary.

The operation can include determining the input length for deblocking filtering on the first and second sides of the potential blocking boundary based on steps that include: determining a first number of consecutive samples values from the sample value closest to the potential blocking boundary on the first side to another sample value closest to a neighboring potential blocking boundary on the first side; determining a second number of consecutive samples values from the sample value closest to the potential blocking boundary on the second side to another sample value closest to a neighboring potential blocking boundary on the second side; and determining the input length based on the lesser one of the first and second numbers.

For example, when the distance from the current potential blocking boundary to the neighboring potential blocking boundary on a first side of the current boundary is 8 samples and the distance from the current potential blocking boundary to the neighboring potential blocking boundary on the second side is 16 samples, the input length for deblocking filtering for the current potential blocking boundary can be set to half of the minimum of both distances, e.g. is set to 4 samples in the given example. The output length for deblocking filtering can in this case either be identical to the input length or at least one sample shorter.

Similarly, when the neighboring potential blocking boundary has an input length of deblocking filtering of 4 samples on each side of the boundary, and an output length of deblocking filtering of 3 samples, the input length for deblocking of the current potential blocking boundary can be set to 5. The output length for deblocking filtering can in this case either be identical to the input length or at least one sample shorter.

### Embodiment 3

In accordance with Embodiment 3, the input length and the output length for deblocking filtering are determined based on the length of the current potential blocking boundary.

For example, to determine the input filter length to be between 4 and 8 samples the length of the current potential blocking boundary should be at least 16 samples long. The output length for deblocking filtering can in this case either be identical to the input length or at least one sample shorter. The reason for this is to avoid frequent switching between very strong deblocking filtering (long deblocking filter length) and weaker deblocking filtering (short deblocking filter length) to avoid introducing edges between very strong and weaker deblocking filtering. If even longer filter lengths are used, the length of the current potential blocking boundary should be at least 32 or 64 samples long.

According to some embodiments, the length of the potential blocking boundary is 4 sample values. In other embodiments, the length of the potential blocking boundary is greater than 4 sample values.

### Embodiment 4

In accordance with Embodiment 4, the input and output deblocking filter length on the first side and the second side of the current potential blocking boundary is determined by the number of consecutive smooth samples in a direction perpendicular to the current potential blocking boundary on the first and second side and optionally also that there is a difference between the sample closest to the boundary on the first side and the sample closest to the boundary on the second side.

Thus, the operations for determining the input length and the output length for deblocking filtering of one of the blocks can be based on a number of consecutive smooth sample values in a direction perpendicular to the potential blocking boundary and optionally also based on a difference between the sample value that is closest to the potential blocking boundary on the first side and the sample value that is closest to the potential blocking boundary on the second side.

For example, to determine the input deblocking filter length to be 4 on a side of the boundary the number of consecutive smooth samples perpendicular to the boundary on that side starting from and including the sample closest to the boundary and at least three more samples further away from the boundary, e.g. in total 4 samples. Smooth samples can be determined by for example according some metric, for example Laplacian metric and the difference between two samples metric as used in HEVC for strong/weak filter decision. With the only difference that they can be computed separately for respective side of the boundary to determine the input length on respective side of the boundary. The output length for deblocking filtering can in this case either be identical to the input length or at least one sample shorter.

Further operations are now explained in the example context of an HEVC condition for strong/weak filter decision but here used to determine 4 smooth samples on respective side of the boundary.
p3 p2 p1 p0 | q0 q1 q2 q3

For first side (q), the operations perform:
Abs(q0−2*q1+q2)<(β>>3) and Abs(q0−q3)<(β>>4) and Abs(p0−q0)<((5*tC+1)>>1)

For second side (p), the operations perform:
Abs(p0−2*p1+p2)<(β>>3) and Abs(p0−p3)<(>>4) and Abs(p0−q0)<((5*tC+1)>>1)

For input deblocking filter lengths larger than 4 samples on a side, a new metric which is insensitive to ramps is defined for the additional samples. Conditions for the 4 samples closest to the boundary, q0 to q3 or p0 to p3 as indicated below, can be based on state of the art, for example the strong/weak decision in HEVC, see numerical example above. The new metric for the additional samples is designed such that it uses two middle samples to “share” the middle coefficient of the Laplacian filter for a sample that are at an even number of samples from the boundary sample and where the middle samples use the middle coefficient of the Laplacian for samples that are an odd number of samples from the boundary.

Example for determining an input deblocking filter length of 8:
p7 p6 p5 p4 p3 p2 p1 p0 | q0 q1 q2 q3 q4 q5 q6 q7

For the first side (q), the operations perform:
Is sample q7 smooth? Odd samples away from the boundary, set the two middle coefficients between q0 and q7 to half of the middle coefficient of the Laplacian to “share” the Laplacian coefficient, e.g. abs(q0−q3−q4+q7)<thr7
Is sample q6 smooth? Even samples away from boundary, set the middle coefficient of the Laplacian in the middle between q0 and q6, e.g. abs(q0−2*q3+q6)<thr6
Is sample q5 smooth? Odd samples away from the boundary, set the two middle coefficients between q0 and q5 to half of the middle coefficient of the Laplacian to “share” the Laplacian coefficient, e.g. abs(q0−q2−q3+q5)<thr5
Is sample q4 smooth? Even samples away from boundary, set the middle coefficient of the Laplacian in the middle between q0 and q4, e.g. abs(q0−2*q2+q4)<thr4

Similarly for the second side (p) as for the first side just using p* instead of q*.

The thresholds thr7, thr6, thr5 and thr4 can be set to a threshold that depends on the QP (quantization parameter) that would be used for deblocking of the potential blocking boundary. If all conditions, including conditions for the 4 samples closest to the boundary, are true for the first side the determined input deblocking filter length is 8 samples for the first side and if all conditions are true for the second side, including conditions for the 4 samples closest to the boundary, the determined input deblocking filter length is 8 samples for the second side. It can also happen that the input length is determined to 6 samples for the first side and 8 samples for the second side due to two conditions furthest away from the boundary are false e.g. they are larger than thr7 and thr6.

A variation of these operations that can be used requires that both sides of the boundary should have smooth samples. Then the conditions for the first 4 samples closest to the boundary on respective side can use the HEVC strong/weak filter decision as is. Then the additional conditions apply for the 4 outmost samples on respective side e.g. both for p7 to p4 and for q7 to q4 as below:
Are q7 and p7 smooth: abs(p0−p3−p4+p7)+abs(q0−q3−q4+q7)<thr7a
Are q6 and p6 smooth: abs(p0−2*p3+p6)+abs(q0−2*q3+q6)<thr6a
Are q5 and p5 smooth: abs(p0−p2−p3+p5)+abs(q0−q2−q3+q5)<thr5a
Are q4 and p4 smooth: abs(p0−2*p2+p4)+abs(q0−2*q2+q4)<thr4a

In one example thr4=thr5=thr6=thr7=(3*beta)>>6, thr4a=thr5a=thr6a=thr7a=(3*beta)>>5 where beta is defined in a lookup table where beta is larger for larger QP. The lookup table could for example be same/similar as the one in HEVC.

If all conditions are true including the conditions for the samples closest to the boundary the determined input deblocking filter length is 8 samples for both sides of the blocking boundary.

A variation of these operations that can be used makes the ramp sensitive metric for q7, q5 also sensitive for an edge between q3 and q4:
q7 smooth?: abs(−q0+7*(q3−q4)+q7)<thr7b
q5 smooth?: abs(−q0+5*(q2−q3)+q5)<thr5b

If all conditions are true for the first side, including conditions for the 4 samples closest to the boundary on the first side, the determined input deblocking filter length is 8 samples for the first side and if all conditions are true for the second side, including conditions for the 4 samples closest to the boundary on the second side, the determined input deblocking filter length is 8 samples for the second side.

Similarly, for the case where the conditions applies for both sides:
Are q7 and p7 smooth: abs(−p0+7*(p3−p4)+p7)+abs(−q0+7*(q3−q4)+q7)<thr7c
Are q5 and p5 smooth: abs(−p0+5*(p2−p3)+p5)+abs(−q0+5*(q2−q3)+q5)<thr5c

In one example thr7c=2*thr7a, thr5c=2*thr5a thr7b=2*thr7

If all conditions are true, including the conditions for the samples closest to the boundary, the determined input deblocking filter length is 8 samples for both sides of the blocking boundary.

It can also happen that conditions for q7 and p7, respectively for q6 and p6 are false but all the conditions for the pixels closer to the block boundary are true. In that case the determined input deblocking filter length is 6 samples for both sides of the blocking boundary.

Here follows an example for a determining an input deblocking filter length of 4:
p3 p2 p1 p0 | q0 q1 q2 q3

The first three samples from the block border can use conditions as in prior art e.g. q0 to q2 and p0 to p2. Here we introduce a new smoothness criterion for the fourth sample e.g. q3 and p3 which is insensitive to a ramp:

First side (q):
q3 smooth?: abs(q0−q1−q2+q3)<thr3

Corresponding operations can be performed for the second side.

If all conditions are true for the first side including conditions for the first three samples closest to the boundary the determined input deblocking filter length is 4 samples for the first side and if all conditions are true for the second side including conditions for the first three samples closest to the boundary the determined input deblocking filter length is 4 samples for the second side.

A variation of these operations that can be used is to require that both sides of the boundary should have smooth samples. Then the conditions apply both for p3 and for q3 as below:
p3 and q3 smooth?: abs(p0−p1−p2+p3)+abs(q0−q1−q2+q3)<thr3a

If all conditions are true, including conditions for the first three samples on respective side, the determined input deblocking filter length is 4 samples for both sides of the blocking boundary.

One alternative design that also is sensitive to an edge between q1 and q2.

First side:
q3 smooth?: abs(−q0+3*(q1−q2)+q3)<thr3b

Corresponding operations can be performed for the second side.

If all conditions are true for the first side including conditions for the first three samples closest to the boundary the determined input deblocking filter length is 4 samples for the first side and if all conditions are true for the second side including conditions for the first three samples closest to the boundary the determined input deblocking filter length is 4 samples for the second side.

Similarly for the case where the conditions apply for both sides:
p3 and q3 smooth?: abs(−p0+3*(p1−p2)+p3)+abs(−q0+3*(q1−q2)+q3)<thr3c

If all conditions are true including conditions for the first three samples on respective side the determined input deblocking filter length is 4 samples for both sides of the blocking boundary.

The thresholds thr3, thr3b and thr3c can be set to a threshold that depends on the QP (quantization parameter) that would be used for deblocking of the potential blocking boundary.

### Embodiment 5

Embodiment 5 can use similar operations to any of the above embodiments, however the input and output deblocking filter length on one side of the current potential blocking boundary is determined based on the width and height of the block on that side.

The output length for deblocking filtering can in this case either be identical to the input length or at least one sample shorter.

Thus, the operations for determining the input length and the output length for deblocking filtering of one of the blocks can be based on width and height of the block on the first side of the potential blocking boundary and width and height of the block on the second side of the potential blocking boundary.

One example operation is to determine the input deblocking filter length to be 8 samples for the side of the current potential blocking boundary that is in the current block when both the width and height of current block is equal or larger than 32. Similarly determine the input deblocking filter length to be 8 samples for the side of the current potential blocking boundary that is in the neighboring block when both the width and height of neighboring block is equal or larger than 32. If the current block is smaller, the input length for deblocking for that side is shorter. If the neighboring block is smaller, the input length for deblocking for that side is shorter.

Another example is to determine the input deblocking filter length to be 6 samples for the side of the current potential blocking boundary that is in the current block when both the width and height of current block is equal or larger than 16. Similarly, the operations determine the input deblocking filter length to be 6 samples for the side of the current potential blocking boundary that is in the neighboring block when both the width and height of neighboring block is equal or larger than 16. If the current block is smaller, the input length for deblocking for that side is shorter. If the neighboring block is smaller, the input length for deblocking for that side is shorter.

Alternative operations that can be used with this embodiment determine the input deblocking filter length based on the width and the height of both the current and the neighboring block.

One example is to determine the input deblocking filter length to be 8 samples on both sides of the current blocking boundary when both the width and height of current block and the neighboring block are equal or larger than 32. If one of the current block or neighboring block is smaller, a shorter input length for deblocking is used.

Another example is to determine the input deblocking filter length to be 6 samples on both sides of the current blocking boundary when both the width and height of current block and the neighboring block are equal or larger than 16. If one of the current block or neighboring block is smaller, a shorter input length for deblocking is used.

### Embodiment 6

In this embodiment, the determination of the input and output deblocking filter length may be performed as in any of above embodiments along the whole current potential blocking boundary covering the full width (if the edge to filter is horizontal) or height (if the edge to be filtered is vertical) of the current block.

Thus, the operations for determining the input length and the output length for deblocking filtering of one of the blocks can use the sample values along the whole potential blocking boundary extending along one of: width of the block when the horizontal edge will be deblocking filtered; and height of the block when the vertical edge will be deblocking filtered.

The distance is determined to the closest neighboring potential blocking boundary that exists at some part of the current potential blocking boundary instead of having a specific distance for each sample or part of samples along the current potential blocking boundary to the closest neighboring potential blocking boundary.

For example, if the current potential blocking boundary is 32 samples long and there is a neighboring potential blocking boundary at some part of the 32 samples at a distance of 4 samples from the current potential blocking boundary, then the input and output deblocking filter length is based on a distance of 4 for all samples along the current potential blocking boundary.

Alternative operations that may be used with this embodiment require that at least a specific number of samples belongs to the neighboring potential blocking boundary to compute the distance to it. One example is 4 samples. Another example is 16 samples. One benefit of this embodiment is that it avoids frequent switching between different deblocking filter lengths along a current potential block boundary unless there is some significant edge. It can also favorize the use deblocking filtering with shorter input and output lengths.

### Embodiment 7

In Embodiment 7, the deblocking filter length is determined to be longer for current potential blocking boundaries that coincide with block boundaries compared to current potential blocking boundaries close to the block boundary inside the blocks. The reason for this is to guarantee that the determined output deblocking filter length can be large across a block boundary and still avoid recursive filtering and thus enable parallel deblocking. The output deblocking filter length at an internal blocking boundary can still be as long as the length of the deblocking filter at the block boundary if it is sufficient far away from the block boundary.

The operation for determining the input length and the output length for deblocking filtering of one of the blocks are determined to be larger values responsive to the potential blocking boundary coinciding with a block boundary of one of the blocks and, in contrast, are determined to be smaller values responsive to the potential blocking boundary not coinciding with the block boundary of the one of the blocks.

A block boundary could here correspond to a coding unit boundary and a block boundary inside a block can correspond to a boundary from a prediction block or a transform block inside the coding unit block. Alternatively, a block boundary could correspond to a coding tree unit (CTU) boundary and a block boundary inside the block can correspond to a boundary from a coding unit block or transform block or a prediction block.

One way of enabling a larger output deblocking filter length is to omit filtering samples adjacent to internal potential blocking boundaries that exist sufficiently close to the block boundary so it can be avoided that deblocking of samples adjacent to internal block boundary reach filtered samples of the deblocking filtering of the block boundary. In some cases it is only possible to filter one side of the internal blocking boundary, e.g., the side that is further away from the block boundary.

For example, if the determined input length for deblocking filtering of a block boundary is N samples and the determined output length is K samples, there must be at least N+1 samples between the block boundary and an internal potential blocking boundary to avoid recursive filtering when deblocking the internal potential blocking boundary, and which thus enables parallel deblocking of vertical edges or horizontal edges.

An internal potential blocking boundary that then is filtered needs to determine the output length for deblocking filtering to M to avoid recursive filtering. M is determined by the difference between the distance between the block boundary and the internal potential blocking boundary and the input length for deblocking filtering of the block boundary N, e.g., D minus N. The determined input length for deblocking of the internal potential blocking boundary is then the distance minus the output length of deblocking filtering of the block boundary, e.g., D minus K. The determination applies to both an internal potential blocking boundary close to the current block boundary but also to an internal potential blocking boundary close to the block boundary on the opposite side of the block.

For example if the determined input length for deblocking of a block boundary is 8 and the output length for deblocking of a block boundary is 7, then the closest internal block boundary that is allowed to be deblocked must be at least 9 samples away. Considering sub-blocks of 4×4 this then correspond to a distance of 12 samples from the block boundary. Then the output deblocking filter length can be determined to be 4 samples and the input deblocking filter length can be determined to be 5 samples for the closest internal block boundary.

In another example, if the determined input length for deblocking of a block boundary is 5 and the determined output length for deblocking is 4, then the closest internal block boundary that is allowed to be deblocked must be at least 6 samples away. Considering sub-blocks of 4×4 this then correspond to a distance of 8 samples from the block boundary. Then can the determined input deblocking filter length can be 4 samples and the determined output length can be 3 samples for the closest internal block boundary.

The operations can start by defining a determined input length for deblocking of the side of the internal boundary closest to the block boundary to be M and the determined output length to be K. Then the determined input length for deblocking for the side of the block boundary adjacent to the internal boundary is the distance D between the boundaries minus K and the determined output length is D minus M. If K is 1 and D is 4 then the input length is 3 and if M is 2 the output length is 2.

Some examples of variants that favor the deblocking filter length for the block boundary compared to an internal boundary. Where “|” indicates an internal boundary, “∥” indicates a block boundary, “n” indicates a sample output by deblocking of a neighboring blocking boundary, “o” corresponds to a sample that is used for input for deblocking but is not output by any deblocking, and “c” corresponds to samples that are output by deblocking of the current boundary.

When D is 16 and the determined input length for deblocking of a block boundary is 9 and the determined output length for deblocking of a block boundary is 8:
   | n n n n n n n o c c c c c c c c ∥ c c c c c c c c o n n n n n n n |

When D is 8 and the determined input length for deblocking of a block boundary is 5 and the determined output length for deblocking of a block boundary is 4:
   | n n n o c c c c ∥ c c c c o n n n |

When D is 4 and the determined input length for deblocking of a block boundary is 3 and the determined output length for deblocking of a block boundary is 2:
   | n o c c ∥ c c o n |

### Embodiment 8

In the previous Embodiment 7, it is noted that by determining the output deblocking filter length to be longer for the block boundary can result in that some internal boundaries are not deblocked or that they only can be deblocked by a short deblocking filter. In contrast for operations according to Embodiment 8, potential blocking boundaries that coincide with the current block boundary are de-blocked together with potential neighboring blocking boundaries inside the current block and inside the neighboring block. These operations adapt the smoothness metric such that it will be true even though there is a discontinuity at an internal potential blocking boundary close to the block boundary.

In a further embodiment, responsive to the potential blocking boundary coinciding with a block boundary of one of the blocks, the input length and the output length for deblocking filtering of one of the blocks are determined so that the sample values along block boundary inside the one of the blocks are deblocking filtered with sample values within a block along a neighboring potential blocking boundary.

When the distance between the current boundary and the neighboring potential block boundaries is 4 samples, a deblocking is performed using a determined input length of 6 samples and a determined output length of 5 samples to deblock both the current boundary and the close neighboring boundary. This can be performed and still allow for modification of 2 pixel of a potential blocking boundary at a distance of 8 samples from the current boundary with non-recursive filtering, which allows parallel processing deblocking filtering of all vertical edges respectively horizontal edges.
o c | c c c c ∥ c c c c | c o n n |

The adaptation of the smoothness metric for this example can be as follows. Consider labeling of the samples q0 to q7 on first side of the block boundary and p0 to p7 on the other side of the block boundary:
p7 p6 p5 p4 | p3 p2 p1 p0 ∥ q0 q1 q2 q3 | q4 q5 q6 q7

The first four consecutive samples adjacent to the block boundary, e.g. q0 to q3 and/or p0 to p3 can use same conditions as in other embodiments or in prior art. Then the smoothness of samples q4 to q5 and/or p4 to p6 is considered by only considering q3 to q5 and/or p3 to p6.

For first side q:
Is q4 and q5 smooth?: abs(q4−q3)<thrA && abs(q4−2*q5+q6)<thrB

If all conditions are true included the conditions for the first four samples adjacent to the block boundary the input length can be 6 samples and the output length can be 5 samples for the first side.

For second side p:
Is p4 and p5 smooth?: abs(p4−p3)<thrA && abs(p4−2*p5+p6)<thrB

If all conditions are true included the conditions for the first four samples adjacent to the block boundary the input length can be 6 samples and the output length can be 5 samples for the second side.

Alternative operations that can be used for Embodiment 8 apply the conditions on both sides and use same filter length on both sides:

Are both p4 and p5 smooth and also q4 and q5 smooth?:
abs(q4−q3)<thrA && (abs(q4−2*q5+q6)+(p4−2*p5+p6))<thrC

If all conditions are true included the conditions for the first four samples adjacent to the block boundary on both sides the input length can be 6 samples and the output length can be 5 samples for both sides of the block boundary.

The thresholds thrA, thrB, thrC can be set to a threshold that depends on the QP (quantization parameter) that would be used for deblocking of the potential blocking boundary.

One example of threshold thrA is ((5*tC+1)>>1) as used in HEVC. Where tC is based on table lookup based on QP.

One example of thrC is beta as used in HEVC. Where beta is based on a table lookup based on QP.

One example of thrB is thrC>>1.

Another example using a determined input length of 8 samples and a determined output length of 7 samples can deblock both the current boundary and the close neighboring boundary.

The adaptation of the smoothness metric for this example can be as follows. Consider labeling of the samples q0 to q7 on first side of the block boundary and p0 to p7 on the other side of the block boundary:
p7 p6 p5 p4 | p3 p2 p1 p0 ∥ q0 q1 q2 q3 | q4 q5 q6 q7

The first four consecutive samples adjacent to the block boundary, e.g. q0 to q3 and/or p0 to p3 can use same conditions as in other embodiments or in prior art. Then the smoothness of samples q4 to q7 and/or p4 to p7 is considered by only considering q3 to q7 and/or p3 to p7.

For first side q:
Is q4 and q5 smooth?: abs(q4−q3)<thrA && abs(q4−2*q5+q6)<thrB
Is q6 and q7 smooth?: abs(q4−q3)<thrA && abs(−q4+3*(q5−q6)+q7)<thrD

If all conditions are true included the conditions for the first four samples adjacent to the block boundary the input length can be 8 samples and the output length can be 7 samples for the first side.

For second side p:
Is p4 and p5 smooth?: abs(p4−p3)<thrA && abs(p4−2*p5+p6)<thrB
Is p6 and p7 smooth?: abs(p4−p3)<thrA && abs(−p4+3*(p5−p6)+p7)<thrD

If all conditions are true included the conditions for the first four samples adjacent to the block boundary the input length can be 8 samples and the output length can be 7 samples for the second side.

Some other alternative operations that can be used for Embodiment 8 apply the conditions on both sides and use same filter length on both sides:
Are both p4 to p7 smooth and also q4 and q7 smooth?:
abs(q4−q3)<thrA && (abs(q4−2*q5+q6)+(p4−2*p5+p6))<thrC && (abs(−q4+3*(q5−q6)+q7)+abs(−p4+3*(p5−p6)+p7))<thrE

If all conditions are true included the conditions for the first four samples adjacent to the block boundary on both sides the input length can be 6 samples and the output length can be 5 samples for both sides of the block boundary.

Example of thresholds thrA, thrB and thrC where given above. Examples of thresholds thrD and thrE are: thrD=thrB and thrE=thrC.

### Embodiment 9

The operations of Embodiment 9 determine the input length and the output length for deblocking filtering of one of the blocks based on distance between current potential blocking boundary and a neighboring potential blocking boundary.

The minimum distance between all pseudo potential blocking boundaries inside the current block is determined. A pseudo potential blocking boundary is a boundary along which it exists at least one part that fulfills at least one criterion to be a potential blocking boundary. Based on the minimum distance between pseudo potential blocking borders of the current block, the deblocking filter length can be determined as half of the minimum distance and be used for deblocking of all potential blocking boundaries inside the current block.

One example of criterion to determine potential blocking boundaries inside the current block is to compare the prediction parameters at respective side of internal boundaries of the block. If prediction parameters differ, the boundary is determined as a potential blocking boundary.

An example grid to use to determine internal boundaries is 4.

Thus, the operation for determining the input length and the output length for deblocking filtering of one of the blocks, can include determining a minimum distance between all pseudo potential blocking boundaries inside the one of the blocks, where a pseudo potential blocking boundary is a boundary having a least a portion of which fulfills at least one criterion to be a potential blocking boundary. The input length and the output length for deblocking filtering of one of the blocks is determined as half of the minimum distance. The deblocking filtering is performed to deblock all pseudo potential blocking boundaries inside the one of the blocks.

### Embodiment 10

The operations of Embodiment 9 determine the input and output deblocking filter length based on distance between current potential blocking boundary and a neighboring potential blocking boundary.

The potential blocking boundaries can be determined as explained in any of above embodiments if the current block or a neighboring block use one of the following sub-block coding modes FRUC, AFFINE, the alternative temporal motion vector prediction (ATMVP) or spatial-temporal motion vector predictor (STMVP). Thus, for example, one of the plurality of blocks and/or a neighboring block uses, as a sub-block coding mode: frame rate up-conversion (FRUC), AFFINE, alternative temporal motion vector prediction (ATMVP), and/or spatial-temporal motion vector predictor (STMVP).

The size for which potential blocking boundaries are determined depends on the smallest sub-block size that the motion compensation methods use. One example that can be used is 4×4. For example, a size for which the potential blocking boundaries are determined is based on a smallest sub-block size used by a motion compensation method performed on the blocks of the video sequence. Further, in at least one embodiment, a smallest sub-block size is 4×4.

One example of criterion to determine potential blocking boundaries inside a block predicted with a sub-block mode is to compare the prediction parameters at respective side of the sub-block boundary. If prediction parameters differ, the boundary is determined as a potential blocking boundary.

### Embodiment 11

The operations of Embodiment 9 are directed to determining the filter length for a first and second side of a potential blocking boundary. These operations may be, but not necessarily are, first applied for vertical boundaries and then for horizontal boundaries:

Step 1: A first operation locates transform and prediction block boundaries in one direction, e.g. vertical boundaries or horizontal boundaries, for a CU, CTU or a picture or slice.

Step 2: A second operation locates parts of the vertical boundaries that were determined in the first operation that fulfill at least one of the following criterions (a part is at least one sample along the boundary):

1. At least one side of the boundary is intra predicted.

2. There is a difference in prediction parameters on respective side of the boundary, such as motion vector, reference picture, LIC parameters, weighted prediction parameters, scaling or offset in motion compensated prediction.

3. There is a difference in residual parameters on respective side of the boundary, such as the one side belongs to one transform block and the other side belongs to another transform block where at least one of the side has non-zero residual parameters, e.g. transform coefficients.

4. There is a difference in pixel values from pixels on respective side of the boundary (this criterion is typically used together with one of the above three criterions).

Step 3: For parts determined in Step 2, determine the input and output length for deblocking filtering of a first side of a current potential blocking boundary based at least on the distance between the current potential blocking boundary to the closest neighboring potential blocking boundary on the first side and the input and output length for deblocking filtering of a second side of a current potential blocking boundary based at least on the distance between the current potential blocking boundary to the closest neighboring potential blocking boundary on the second side.

Step 4: For parts determined in Step 2, determine the number of consecutive smooth samples perpendicular to the potential blocking boundary on respective sides of the boundary. In one embodiment, for each of the parts of vertical boundaries, Step 4 determines a number of consecutive smooth samples perpendicular to the potential blocking boundary on both of the first and second sides.

Step 5: For parts determined in Step 2, determine the width and height of current transform block and the width and the height of the neighboring transform block.

Step 6: Count the number of parts that fulfills the determinations performed in Step 3, Step 4 and Step 5.

Step 7: Determine the length of the deblocking filter for the first side and the length of the deblocking filter for the second side based on Steps 3 to 6.

Step 8: Deblock first side and second side based on Step 7.

### Embodiment 12

The operations according to Embodiment 12 first deblock potential blocking boundaries (vertical or horizontal) inside the current block and then deblock the current block boundary (vertical or horizontal). By current block, we here mean one component of a unit. The luma component of a CU is an example of a current block. The current block boundary refers to the top and left border of the current block for deblocking of horizontal and vertical boundaries respectively.

These operations may be performed by first filtering across vertical potential deblocking boundaries inside the current block. In this embodiment, filtering of all vertical internal potential deblocking boundaries is designed such that filtering is done by only reading and modifying samples that are inside the current block. Additionally, filtering of the vertical internal potential deblocking boundaries is designed such that filtering of any particular vertical internal boundary does not modify any sample that is read during filtering of any other vertical internal boundary.

Then a second filtering of the current block boundary is done such that it only reads samples that are not modified by the filtering of the current block boundary of a neighboring current block (e.g. by the filtering of the boundaries of any neighboring CU). The design of the first and second filtering means that filtering of vertical potential deblocking boundaries can be done in parallel, and that filtering of current blocks (e.g. filtering of CUs) can be done in parallel. Note that the second filtering may read samples that are modified by the first filtering.

One benefit of this approach is that it can address both blocking artifacts inside blocks due to, for example, boundaries between sub-block with different motion and also address blocking artifacts from boundaries between large blocks (e.g. CUs). By doing the deblocking first internally in the block can help to apply longer deblocking filters on the block boundary. By doing the filtering of internal sub-block boundaries inside the block without overlap in filtering of other internal sub-block boundaries inside the block such filtering can be performed in parallel.

Example of operations for deblocking of vertical boundaries, include:

A first filter operation is performed across vertical potential deblocking boundaries inside the current block without overlap in filtering with neighboring block's vertical boundary samples. The filtering may be performed by limiting the maximum input and output deblocking filter length for a potential blocking boundary to the distance from the potential internal blocking boundary to the closest vertical current block boundary. For example, if the distance is 4 the input filter length is set to be a maximum 4 samples and the output length to maximum 4 samples. If the distance is 8 the input filter length is set to be a maximum 8 samples and the output length to maximum 8 samples.

A second filter operation is then performed across the vertical boundary of the current block without overlap to filtering of vertical boundaries of other current blocks (e.g. other CUs). The filtering may be performed by limiting the maximum input and output deblocking filter length for current block's vertical boundary to half the distance from the current block boundary to the closest neighboring current block's vertical boundary. For example, if the distance is 8 the input and output filter length is set to be a maximum of 4 samples. If the distance is 16, the input and output filter length is set to be a maximum of 8 samples.

Deblocking of horizontal boundaries is done similar to what is described for vertical boundaries above. These operations may be performed by first filtering across horizontal potential deblocking boundaries inside the current block. In this embodiment, filtering of all horizontal internal potential deblocking boundaries is designed such that filtering is done by only reading and modifying samples that are inside the current block. Additionally, filtering of the horizontal internal potential deblocking boundaries is designed such that filtering of any particular horizontal internal boundary does not modify any sample that is read during filtering of any other horizontal internal boundary.

Then a second filtering of the current block boundary is done such that it only reads samples that are not modified by the filtering of the current block boundary of a neighboring current block (e.g. by the filtering of the boundaries of any neighboring CU). The design of the first and second filtering means that filtering of horizontal potential deblocking boundaries can be done in parallel, and that filtering of current blocks (e.g. filtering of CUs) can be done in parallel. Note that the second filtering may read samples that are modified by the first filtering.

### Embodiment 13

This embodiment contains a specific implementation of deblocking decisions for super strong deblocking and deblocking of internal CU boundaries before deblocking CU boundaries. The implementation supports parallel friendly deblocking. The super strong deblocking filters and the HEVC deblocking filters are used here as an example of deblocking filters.

The super strong deblocking filters are designed to linearly interpolate from a virtual sample value on respective side of the block boundary (refQ, refP) towards a virtual sample value centered in the middle of the block boundary (refMiddle) along a line of sample values perpendicular to the block boundary. The filtering of one sample along the i:th line of samples is described below:
pᵢ′(x)=Clip3(pᵢ(x)−tc, pᵢ(x)+tc, (f(x)*refMiddleᵢ+(64−f(x))*refPᵢ+32)>>6
qᵢ′(x)=Clip3(qᵢ(x)−tc, qᵢ(x)+tc, (f(x)*refMiddleᵢ+(64−f(x))*refQᵢ+32)>>6

where pᵢ(0) is the sample value closest to the block boundary in block P and qᵢ(0) is the sample value closest to the block boundary in block Q for line i, where for 3 sample filtering on each side:
x ranges from 0 to 2
f={53, 32, 11}
refPᵢ=(pᵢ(3)+pᵢ(2)+1)>>1
reqQᵢ=(qᵢ(3)+qᵢ(2)+1)>>1
refMiddleᵢ=(2*(pᵢ(2)+qᵢ(2))+3*(pᵢ (1)+pᵢ(0)+qᵢ(0)+qᵢ(1))+8)>>4
   In this example input length is equal to 4 on respective side and output length is 3 on respective side.

where for 5 sample filtering on each side:
x ranges from 0 to 4
f={58, 45, 32, 19, 6}
refPᵢ=(pᵢ(5)+pᵢ(4)+1)>>1
reqQᵢ=(qᵢ(5)+qᵢ(4)+1)>>1
refMiddleᵢ=(pᵢ(4)+pᵢ(3)+qᵢ(3)+qᵢ(4)+2*(pᵢ(2)+pᵢ(1)+pᵢ(0)+qᵢ(0)+qᵢ(1)+qᵢ(2))+8)>>4
   In this example input length is equal to 6 on respective side and output length is 5 on respective side.

where for 7 sample filtering on each side:
x ranges from 0 to 6
f={59, 50, 41, 32, 23, 14, 5}
refPᵢ=(pᵢ(7)+pᵢ(6)+1)>>1
reqQᵢ=(qᵢ(7)+qᵢ(6)+1)>>1
refMiddleᵢ=(pᵢ(6)+pᵢ(5)+pᵢ(4)+pᵢ(3)+pᵢ(2)+pᵢ(1)+qᵢ(1)+qᵢ(2)+qᵢ(3)+qᵢ(4)+qᵢ(5)+qᵢ(6)+2*(pᵢ(0)+qᵢ(0))+8)>>4
   In this example input length is equal to 8 on respective side and output length is 7 on respective side.

To determine when to use the super strong filters some additional conditions in addition to boundary strength larger than 0 and that d is less than beta (for two lines a four-sample part of the block boundary) needs to be true (as for HEVC deblocking filtering) as follows.

A super strong filter that filters seven pixels on each side of the block boundary is used when both current CU and neighboring CU has a width >=32 and a height >=32 and an additional metric (dss7ᵢ) based on the HEVC strong deblocking filter decision (dsᵢ) and a second decision are true for 8 lines of a 16-sample part of the block boundary. A 16 sample part j corresponds to 8 lines where i can have the following values 16*j+0, 16*j+3, 16*j+4, 16*j+7, 16*j+8, 16*j+11, 16*j+12 and 16*j+15 where j can be 0 to N−1 where N is the length of the block boundary divided by 16.

Where dss7ᵢ=dsᵢ && (|(pᵢ(0)−2*pᵢ(2)+p(4)|+|(qᵢ(0)−2*qᵢ(2)+qᵢ(4)|)<((beta*3)>>5) &&
(|(pᵢ(0)−pᵢ(2)−p(3)+pᵢ(5)|+|(qᵢ(0)−qᵢ(2)−qᵢ(3)+qᵢ(5)|)<((beta*3)>>5) &&
(|(pᵢ(0)−2*pᵢ(3)+pᵢ(6)|+|(qᵢ(0)−2*qᵢ(3)+qᵢ(6)|)<((beta*3)>>5) &&
(|(pᵢ(0)−pᵢ(3)−pᵢ(4)+pᵢ(7)|+|(qᵢ(0)−qᵢ(3)−qᵢ(4)+qᵢ(7)|)<((beta*3)>>5)

If the above super strong filter decision is false a super strong filter that filters five pixels on each side of the block boundary is used when both current CU and neighboring CU has a width >=16 and a height >=16 and an additional metric (dss5ᵢ) based on the HEVC strong deblocking filter decision (dsᵢ) and a second decision are true for 8 lines of a 16 sample part of the block boundary.
Where dss5ᵢ=dsᵢ && (|pᵢ(0)−pᵢ(4)|+|qᵢ(0)−qᵢ(4)|)<(beta>>3) && (|pᵢ(0)−pᵢ(5)+|qᵢ(0)−qᵢ(5)|)|<(beta>>3)

If none of above super strong filter decision are true a super strong filter that filters three pixels on each side of the block boundary is used when both current CU and neighboring CU has a width >=8 and a height >=8 and an additional metric (dss3ᵢ) based on the HEVC strong deblocking filter decision (dsᵢ) and a second decision are true for 8 lines of a 16 sample part of the block boundary.
Where dss3ᵢ=dsᵢ && (|pᵢ(0)−pᵢ(1)−pᵢ(2)+pᵢ(3)|+|qᵢ(0)−qᵢ(1)−qᵢ(2)+qᵢ(3)|)<((beta*3)>>5)

If none of above super strong filter decisions are true the HEVC deblocking filter and decisions are used for respective 4 lines part of the block boundary with a constraint on the number of samples to read and modify on respective side of the CU boundary to avoid recursive filtering between CUs since the filtering is here applied down to a 4 sample grid (HEVC used a 8 sample grid). For a vertical boundary the number of samples to read and modify for the line in block P is constrained to half the width of block P and for block Q it is constrained to half the width of block Q. For a horizontal boundary this corresponds to constraining the number of samples to read and modify for filtering the line in block P to the half the height of block P and for the line in block Q it is constrained to half the height of block Q. The HEVC strong deblocking filter can be used if both blocks can read at least four samples on the line. Two sample HEVC weak deblocking filtering can be used for side Q if at least three samples from the line in the block Q can be read and two sample HEVC weak deblocking filtering can be used for side P if at least three samples from the line in the block P can be read. One sample HEVC weak deblocking filtering can be used for side Q if at least two samples can be read from the line in the block Q and one sample HEVC weak deblocking filtering can be used for side P if at least two samples can be read from the line in the block P. In the example of one sample HEVC weak deblocking filter the input length is 2 and the output length is 1 on respective side.

To combat blocking artifacts inside luma coded blocks originating from sub-block motion compensation inside the prediction block of a CU, vertical internal potential blocking boundaries are filtered before the vertical CU boundaries of the luma coded blocks are filtered. Similarly, are horizontal internal potential blocking boundaries filtered before the horizontal CU boundaries of luma coded blocks are filtered. The description below describes on filtering of vertical internal boundaries and vertical CU boundaries of the luma coded blocks. Horizontal filtering is done similarly.

A vertical internal blocking boundary may be filtered if at least one of the following conditions true
if any of the absolute value the difference between motion vector components for the two sides of the internal boundary exceeds a threshold
if different reference pictures are used for the two sides of the internal boundary or
if different number of reference pictures are used for the two sides of the internal boundary.

Deblocking of vertical internal potential blocking boundaries use a boundary strength equal to 1 and only read and modifies samples within luma coded blocks of the CU. The number of samples to read and modify as part of the filtering is at most equal to half of the minimal distance between the current vertical internal blocking boundary and the closest neighboring vertical internal potential deblocking boundary to avoid reading samples that are modified by filtering of the closest neighboring vertical internal blocking boundary. Thus, the filtering of vertical internal blocking boundaries for different CUs can be done in parallel.

The filtering of vertical CU boundaries of luma coded blocks can be done in parallel after internal boundaries of luma coded blocks have been filtered.

In some embodiments, the input length and the output length for deblocking filtering are determined (1100) based on a number of consecutive sample values from the sample value closest to the potential blocking boundary to another sample value closest to a closest neighboring potential blocking boundary, wherein the input length is determined to be 8 and the output length is determined to be 7, and wherein deblocking filtering comprises linearly interpolating from a virtual sample value on one side of the potential blocking boundary (refQ, refP) towards a virtual sample value centered in the middle of the potential blocking boundary (refMiddle) along a line of sample values perpendicular to the potential blocking boundary. In some embodiments, deblocking filtering of one sample along the line of samples is operated according to:
p′(x)=Clip3(p(x)−tc, p(x)+tc, (f(x)*refMiddle+(64−f(x))*refP+32)>>6; and/or
q′(x)=Clip3(q(x)−tc, q(x)+tc, (f(x)*refMiddle+(64−f(x))*refQ+32)>>6;
   wherein x ranges from 0 to 6, p(0) is the sample value closest to the potential blocking boundary in a block P, and q(0) is the sample value closest to the potential blocking boundary in a block Q for the line of samples.

### LISTING OF EXAMPLE EMBODIMENTS

Example Embodiments are discussed below. Reference numbers/letters are provided in parenthesis by way of example/illustration without limiting example embodiments to particular elements indicated by reference numbers/letters.

1. A method of processing a video sequence including a plurality of images, with each image of the plurality of images including a plurality of blocks of sample values, the method comprising:

determining (1100) an input length and an output length for deblocking filtering of the sample values for respectively a first side and a second side of a potential blocking boundary, wherein the input length and the output lengths can be different and are a number of consecutive samples values from a sample value that is closest to the potential blocking boundary to one or more other sample values spaced from the potential blocking boundary, and wherein the input length and the output length are determined based on at least one of:
determining (1102) whether a discontinuity is identified between at least one sample value on the first side and adjacent to the potential blocking boundary and at least one sample value on the second side and adjacent to the potential blocking boundary;
determining (1104) a number of consecutive smooth sample values perpendicular to the potential blocking boundary on respectively the first side and the second side of the potential blocking boundary;
determining (1106) width and height of the block on the first side of the potential blocking boundary and width and height of the block on the second side of the potential blocking boundary;
determining (1108) whether the potential blocking boundary is identified as an internal sub-block boundary; and
determining (1110) a number of consecutive samples values from the sample value closest to the potential blocking boundary to another sample value closest to a neighboring potential blocking boundary; and

performing (1112) deblocking filtering of the sample values on the at least one of the first side and the second side of the potential blocking boundary, using the input length and the output length that are determined, to generate deblocked sample values.

2. The method of Embodiment 1, wherein the output length that is determined for deblocking filtering is restricted to not being greater than the input length that is determined for deblocking filtering.

3. The method of any of Embodiments 1 to 2, wherein the input length and the output length for deblocking filtering are determined based on a number of consecutive samples values from the sample value closest to the potential blocking boundary to another sample value closest to a closest neighboring potential blocking boundary.

4. The method of any of Embodiments 1 to 3, wherein a same value is determined for the input length for deblocking filtering for the first and second sides of the potential blocking boundary, and a same value is determined for the output length for deblocking filtering for the first and second sides of the potential blocking boundary.

5. The method of Embodiment 4, the input length for deblocking filtering on the first and second sides of the potential blocking boundary is determined based on:

determining a first number of consecutive samples values from the sample value closest to the potential blocking boundary on the first side to another sample value closest to a neighboring potential blocking boundary on the first side;

determining a second number of consecutive samples values from the sample value closest to the potential blocking boundary on the second side to another sample value closest to a neighboring potential blocking boundary on the second side; and

determining the input length based on the lesser one of the first and second numbers.

6. The method of any of Embodiments 1 to 5, the input length and the output length for deblocking filtering are determined based on length of the potential blocking boundary.

7. The method of any of Embodiments 1 to 6, the input length and the output length for deblocking filtering are determined based on a number of consecutive smooth sample values in a direction perpendicular to the potential blocking boundary.

8. The method of any of Embodiments 1 to 7, the input length and the output length for deblocking filtering are determined based on width and height of the block on the first side of the potential blocking boundary and width and height of the block on the second side of the potential blocking boundary.

9. The method of any of Embodiments 1 to 8, the input length and the output length for deblocking filtering of one of the blocks are determined based on the sample values along the whole potential blocking boundary extending along one of: width of the block when the horizontal edge will be deblocking filtered; and height of the block when the vertical edge will be deblocking filtered.

10. The method of any of Embodiments 1 to 9, the input length and the output length for deblocking filtering of one of the blocks are determined to be longer responsive to the potential blocking boundary coinciding with a block boundary of one of the blocks and are determined to be shorter responsive to the potential blocking boundary not coinciding with the block boundary of the one of the blocks.

11. The method of any of Embodiments 1 to 10, responsive to the potential blocking boundary coinciding with a block boundary of one of the blocks, the input length and the output length for deblocking filtering of one of the blocks are determined so that the determination of the number of consecutive smooth samples perpendicular to the block boundary is adapted to also be true although it crosses an neighboring potential blocking boundary within a block.

12. The method of any of Embodiments 1 to 11, wherein the determination of the input length and the output length for deblocking filtering of one of the blocks, comprises:

determining a minimum distance between all pseudo potential blocking boundaries inside the one of the blocks, wherein a pseudo potential blocking boundary is a boundary having a least a portion of which fulfills at least one criterion to be a potential blocking boundary; and

determining the input length and the output length for deblocking filtering of one of the blocks as half of the minimum distance,

wherein the deblocking filtering is performed to deblock all pseudo potential blocking boundaries inside the one of the blocks.

13. The method of any of Embodiments 1 to 12, wherein size of the potential blocking boundary is determined based on a smallest sub-block size used by a motion compensation method performed on the blocks of the video sequence.

14. The method of any of Embodiments 1 to 13, determination of the input length and the output length for deblocking filtering of one of the blocks, comprises:

1) locating transform and prediction block boundaries in one direction;

2) locating parts of vertical boundaries that fulfill at least one of the following criterion:
at least one side of the vertical boundary is intra predicted;
a difference exists between prediction parameters on opposite sides of the vertical boundary;
a difference exists between residual parameters on opposite sides of the vertical boundary; and
a difference exists between pixel values from pixels on opposite sides of the vertical boundary;

3) for each of the parts of vertical boundaries, determining the input length and the output length for deblocking filtering of the first side of the potential blocking boundary based at least on the distance between the potential blocking boundary to the neighboring potential blocking boundary on the first side;

4) for each of the parts of vertical boundaries, determining the input length and the output length for deblocking filtering of the second side of the potential blocking boundary based at least on the distance between the potential blocking boundary to the neighboring potential blocking boundary on the second side;

5) for each of the parts of vertical boundaries, determining a number of consecutive smooth samples perpendicular to the potential blocking boundary on both of the first and second sides;

6) for each of the parts of vertical boundaries, determining the width and height of a current transform block and the width and the height of a neighboring transform block;

7) counting the number of the parts that satisfy the determinations in 3) through 6); and

8) determining the input length and the output length for deblocking filtering of the first side and the determining the input length and the output length for deblocking filtering of the second side based on 3) through 7),

wherein the deblocking filtering is performed using the input lengths and the output lengths that are determined.

15. The method of any of Embodiments 1 to 14, wherein the deblocking filtering of the sample values on the at least one of the first side and the second side of the potential blocking boundary, comprises:

performing a first filtering of all vertical internal potential deblocking boundaries by only reading and modifying sample values that are inside the one of the blocks, and then performing a second filtering across at least one vertical potential deblocking boundary of the one of the blocks by only reading and modifying sample values that have not been modified during filtering of any other vertical potential deblocking boundary.

16. The method of any of Embodiments 1 to 15, wherein the deblocking filtering of the sample values on the at least one of the first side and the second side of the potential blocking boundary, comprises:

linearly interpolating from a virtual sample value on one side of the potential blocking boundary toward another virtual sample value that is centered in the middle of the potential blocking boundary along a line of sample values perpendicular to the potential blocking boundary.

17. The method of any of Embodiments 1 to 16, further comprising:

generating a decoded video sequence including a decoded image containing the deblocked sample values.

18. The method of any of Embodiments 1 to 16, further comprising:

generating an encoded video sequence based on the deblocked sample values.

19. An electronic device (500) adapted to perform operations according to any of Embodiments 1 through 18.

20. An electronic device (500) comprising:

a processor (503) configured to perform operations according to any of Embodiments 1 through 18.

21. An electronic device configured to perform operations comprising:

determining an input length and an output length for deblocking filtering of the sample values on respectively a first side and a second side of a potential blocking boundary, wherein the input length and the output lengths can be different and are a number of consecutive samples values from a sample value that is closest to the potential blocking boundary to one or more other sample values spaced from the potential blocking boundary, and wherein the input length and the output length are determined based on at least one of:
whether a discontinuity is identified between at least one sample value on the first side and adjacent to the potential blocking boundary and at least one sample value on the second side and adjacent to the potential blocking boundary;
a number of consecutive smooth sample values perpendicular to the potential blocking boundary on respectively the first side and the second side of the potential blocking boundary;
width and height of the block on the first side of the potential blocking boundary and width and height of the block on the second side of the potential blocking boundary;
whether the potential blocking boundary is identified as an internal sub-block boundary; and
a number of consecutive samples values from the sample value closest to the potential blocking boundary to another sample value closest to a neighboring potential blocking boundary; and

performing deblocking filtering of the sample values on the at least one of the first side and the second side of the potential blocking boundary, using the input length and the output length that are determined, to generate deblocked sample values.

### ADDITIONAL EXPLANATION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. QQ1: A wireless network in accordance with some embodiments.

Although the subject matter described herein may be implemented in any appropriate type of system using any suitable components, the embodiments disclosed herein are described in relation to a wireless network, such as the example wireless network illustrated in FIG. QQ1. For simplicity, the wireless network of FIG. QQ1 only depicts network QQ106, network nodes QQ160 and QQ160b, and WDs QQ110, QQ110b, and QQ110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node QQ160 and wireless device (WD) QQ110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and WD QQ110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. QQ1, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of FIG. QQ1 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units.

In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signalling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or WDs via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in FIG. QQ1 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, WiFi, WiMAX, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110, and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network, and allow them to benefit from the functionality described herein.

Auxiliary equipment QQ134 is operable to provide more specific functionality which may not be generally performed by WDs. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

FIG. QQ2: User Equipment in accordance with some embodiments

FIG. QQ2 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE QQ2200 may be any UE identified by the 3rd Generation Partnership Project (3GPP), including a NB-IoT UE, a machine type communication (MTC) UE, and/or an enhanced MTC (eMTC) UE. UE QQ200, as illustrated in FIG. QQ2, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. QQ2 is a UE, the components discussed herein are equally applicable to a WD, and vice-versa.

In FIG. QQ2, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the like, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain UEs may utilize all of the components shown in FIG. QQ2, or only a subset of the components. The level of integration between the components may vary from one UE to another UE. Further, certain UEs may contain multiple instances of a component, such as multiple processors, memories, transceivers, transmitters, receivers, etc.

In FIG. QQ2, processing circuitry QQ201 may be configured to process computer instructions and data. Processing circuitry QQ201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another output device, or any combination thereof. UE QQ200 may be configured to use an input device via input/output interface QQ205 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. QQ2, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof. For example, network QQ243a may comprise a Wi-Fi network. Network connection interface QQ211 may be configured to include a receiver and a transmitter interface used to communicate with one or more other devices over a communication network according to one or more communication protocols, such as Ethernet, TCP/IP, SONET, ATM, or the like. Network connection interface QQ211 may implement receiver and transmitter functionality appropriate to the communication network links (e.g., optical, electrical, and the like). The transmitter and receiver functions may share circuit components, software or firmware, or alternatively may be implemented separately.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by UE QQ200, any of a variety of various operating systems or combinations of operating systems.

Storage medium QQ221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow UE QQ200 to access computer-executable instructions, application programs or the like, stored on transitory or non-transitory memory media, to off-load data, or to upload data. An article of manufacture, such as one utilizing a communication system may be tangibly embodied in storage medium QQ221, which may comprise a device readable medium.

In FIG. QQ2, processing circuitry QQ201 may be configured to communicate with network QQ243b using communication subsystem QQ231. Network QQ243a and network QQ243b may be the same network or networks or different network or networks. Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another WD, UE, or base station of a radio access network (RAN) according to one or more communication protocols, such as IEEE 802. QQ2, CDMA, WCDMA, GSM, LTE, UTRAN, WiMax, or the like. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software or firmware, or alternatively may be implemented separately.

In the illustrated embodiment, the communication functions of communication subsystem QQ231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem QQ231 may include cellular communication, Wi-Fi communication, Bluetooth communication, and GPS communication. Network QQ243b may encompass wired and/or wireless networks such as a local-area network (LAN), a wide-area network (WAN), a computer network, a wireless network, a telecommunications network, another like network or any combination thereof. For example, network QQ243b may be a cellular network, a Wi-Fi network, and/or a near-field network. Power source QQ213 may be configured to provide alternating current (AC) or direct current (DC) power to components of UE QQ200.

The features, benefits and/or functions described herein may be implemented in one of the components of UE QQ200 or partitioned across multiple components of UE QQ200. Further, the features, benefits, and/or functions described herein may be implemented in any combination of hardware, software or firmware. In one example, communication subsystem QQ231 may be configured to include any of the components described herein. Further, processing circuitry QQ201 may be configured to communicate with any of such components over bus QQ202. In another example, any of such components may be represented by program instructions stored in memory that when executed by processing circuitry QQ201 perform the corresponding functions described herein. In another example, the functionality of any of such components may be partitioned between processing circuitry QQ201 and communication subsystem QQ231. In another example, the non-computationally intensive functions of any of such components may be implemented in software or firmware and the computationally intensive functions may be implemented in hardware.

FIG. QQ3: Virtualization environment in accordance with some embodiments

FIG. QQ3 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments QQ300 hosted by one or more of hardware nodes QQ330. Further, in embodiments in which the virtual node is not a radio access node or does not require radio connectivity (e.g., a core network node), then the network node may be entirely virtualized.

The functions may be implemented by one or more applications QQ320 (which may alternatively be called software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, comprises general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may comprise memory QQ390-1 which may be non-persistent memory for temporarily storing instructions QQ395 or software executed by processing circuitry QQ360. Each hardware device may comprise one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, comprise virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears like networking hardware to virtual machine QQ340.

As shown in FIG. QQ3, hardware QQ330 may be a standalone network node with generic or specific components. Hardware QQ330 may comprise antenna QQ3225 and may implement some functions via virtualization. Alternatively, hardware QQ330 may be part of a larger cluster of hardware (e.g. such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network elements (VNE).

Still in the context of NFV, Virtual Network Function (VNF) is responsible for handling specific network functions that run in one or more virtual machines QQ340 on top of hardware networking infrastructure QQ330 and corresponds to application QQ320 in FIG. QQ3.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in combination with the virtual components to provide a virtual node with radio capabilities, such as a radio access node or a base station.

In some embodiments, some signalling can be affected with the use of control system QQ3230 which may alternatively be used for communication between the hardware nodes QQ330 and radio units QQ3200.

FIG. QQ4: Telecommunication network connected via an intermediate network to a host computer in accordance with some embodiments.

With reference to FIGURE QQ4, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of FIG. QQ4 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

FIG. QQ5: Host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. QQ5. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in FIG. QQ5) served by base station QQ520. Communication interface QQ526 may be configured to facilitate connection QQ560 to host computer QQ510. Connection QQ560 may be direct or it may pass through a core network (not shown in FIG. QQ5) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. Its hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in FIG. QQ5 may be similar or identical to host computer QQ430, one of base stations QQ412a, QQ412b, QQ412c and one of UEs QQ491, QQ492 of FIG. QQ4, respectively. This is to say, the inner workings of these entities may be as shown in FIG. QQ5 and independently, the surrounding network topology may be that of FIG. QQ4.

In FIG. QQ5, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments may improve the performance of OTT services provided to UE QQ530 using OTT connection QQ550, in which wireless connection QQ570 forms the last segment. More precisely, the teachings of these embodiments may improve the deblock filtering for video processing and thereby provide benefits such as improved video encoding and/or decoding.

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above, or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

FIG. QQ6: Methods implemented in a communication system including a host computer, a base station and a user equipment in accordance with some embodiments.

FIG. QQ6 is a flowchart illustrating a method implemented in a communication system, in accordance with one embodiment. The communication system includes a host computer, a base station and a UE which may be those described with reference to FIGS. QQ4 and QQ5. For simplicity of the present disclosure, only drawing references to FIG. QQ6 will be included in this section. In step QQ610, the host computer provides user data. In substep QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

FIG. QQ7: Methods implemented in a communication system including a host computer, a base station and a user equipment in accordance with some embodiments.

FIG. QQ7 is a flowchart illustrating a method implemented in a communication system, in accordance with one embodiment. The communication system includes a host computer, a base station and a UE which may be those described with reference to FIGS. QQ4 and QQ5. For simplicity of the present disclosure, only drawing references to FIG. QQ7 will be included in this section. In step QQ710 of the method, the host computer provides user data. In an optional substep (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

FIG. QQ8: Methods implemented in a communication system including a host computer, a base station and a user equipment in accordance with some embodiments.

FIG. QQ8 is a flowchart illustrating a method implemented in a communication system, in accordance with one embodiment. The communication system includes a host computer, a base station and a UE which may be those described with reference to FIGS. QQ4 and QQ5. For simplicity of the present disclosure, only drawing references to FIG. QQ8 will be included in this section. In step QQ810 (which may be optional), the UE receives input data provided by the host computer. Additionally or alternatively, in step QQ820, the UE provides user data. In substep QQ821 (which may be optional) of step QQ820, the UE provides the user data by executing a client application. In substep QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in substep QQ830 (which may be optional), transmission of the user data to the host computer. In step QQ840 of the method, the host computer receives the user data transmitted from the UE, in accordance with the teachings of the embodiments described throughout this disclosure.

FIG. QQ9: Methods implemented in a communication system including a host computer, a base station and a user equipment in accordance with some embodiments.

FIG. QQ9 is a flowchart illustrating a method implemented in a communication system, in accordance with one embodiment. The communication system includes a host computer, a base station and a UE which may be those described with reference to FIGS. QQ4 and QQ5. For simplicity of the present disclosure, only drawing references to FIG. QQ9 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LIC Local Illumination Compensation
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLANWide Local Area Network

Further definitions are provided below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1. A method of processing a video sequence including a plurality of images, with each image of the plurality of images including a plurality of blocks of sample values, the method comprising:
determining an input length and an output length for deblocking filtering of the sample values for respectively a first side and a second side of a potential blocking boundary, wherein the input length and the output length can be different and are a number of consecutive sample values from a sample value that is closest to the potential blocking boundary to one or more other sample values spaced from the potential blocking boundary, and wherein the input length and the output length are determined based on determining a number of consecutive sample values from the sample value closest to the potential blocking boundary to another sample value closest to a neighboring potential blocking boundary; and
performing deblocking filtering of the sample values on the at least one of the first side and the second side of the potential blocking boundary, using the input length and the output length that are determined, to generate deblocked sample values.

2. The method of claim 1, wherein the input length includes is at least one sample on a respective side of the potential blocking boundary, and the output length is at least non-zero for one side of the potential blocking boundary.

3. The method of claim 1, wherein the output length that is determined for deblocking filtering is restricted to not being greater than the input length that is determined for deblocking filtering.

4. The method of claim 1, wherein the input length and the output length for deblocking filtering are determined based on a number of consecutive sample values from the sample value closest to the potential blocking boundary to another sample value closest to a closest neighboring potential blocking boundary.

5. The method of claim 1, wherein the input length is determined to be equal to half of the distance between the current potential blocking boundary and the neighboring potential blocking boundary, and wherein the input length only covers samples that are not modified by deblocking of the neighboring potential blocking boundary.

6. The method of claim 1, wherein a same value is determined for the input length for deblocking filtering for the first and second sides of the potential blocking boundary, and a same value is determined for the output length for deblocking filtering for the first and second sides of the potential blocking boundary.

7. The method of claim 1, wherein the input length for deblocking filtering on the first and second sides of the potential blocking boundary is determined based on:
determining a first number of consecutive sample values from the sample value closest to the potential blocking boundary on the first side to another sample value closest to a neighboring potential blocking boundary on the first side;
determining a second number of consecutive sample values from the sample value closest to the potential blocking boundary on the second side to another sample value closest to a neighboring potential blocking boundary on the second side; and
determining the input length based on a lesser one of the first and second numbers.

8. The method of claim 1, wherein the input length and the output length for deblocking filtering are further determined based on a length of the potential blocking boundary.

9. The method of claim 8, wherein the length of the potential blocking boundary is 4 sample values.

10. The method of claim 8, wherein the length of the potential blocking boundary is greater than 4 sample values.

11. The method of claim 1, wherein the input length and the output length for deblocking filtering are further determined based on a number of consecutive smooth sample values in a direction perpendicular to the potential blocking boundary.

12. The method of claim 1, wherein the input length and the output length for deblocking filtering are further determined based on a width and a height of a block on the first side of the potential blocking boundary and/or a width and a height of a block on the second side of the potential blocking boundary.

13. The method of claim 1, wherein the input length and the output length for deblocking filtering of one of the plurality of blocks are determined based on the sample values along the whole potential blocking boundary extending along one of a width of the one of the plurality of blocks when the horizontal edge will be deblocking filtered and/or height of the one of the plurality of blocks when the vertical edge will be deblocking filtered.

14. The method of claim 1, wherein the input length and the output length for deblocking filtering of one of the plurality of blocks are determined to be longer responsive to the potential blocking boundary coinciding with a block boundary of one of the plurality of blocks and are determined to be shorter responsive to the potential blocking boundary not coinciding with the block boundary of the one of the plurality of blocks.

15. The method of claim 1, wherein a size for which the potential blocking boundaries are determined is based on a smallest sub-block size used by a motion compensation method performed on the blocks of the video sequence.

16. The method of claim 15, wherein a smallest sub-block size is 4×4.

17. The method of claim 1, wherein determining the input length and the output length for deblocking filtering of one of the plurality of blocks, comprises:
1) locating transform block boundaries and prediction block boundaries in a first direction;
2) locating parts of vertical boundaries that fulfill at least one of the following criterion:
at least one side of the vertical boundary is intra predicted;
a difference exists between prediction parameters on opposite sides of the vertical boundary;
a difference exists between residual parameters on opposite sides of the vertical boundary; and
a difference exists between pixel values from pixels on opposite sides of the vertical boundary;
3) for each of the parts of vertical boundaries, determining the input length and the output length for deblocking filtering of the first side of the potential blocking boundary based at least on the distance between the potential blocking boundary to the neighboring potential blocking boundary on the first side;
4) for each of the parts of vertical boundaries, determining the input length and the output length for deblocking filtering of the second side of the potential blocking boundary based at least on the distance between the potential blocking boundary to the neighboring potential blocking boundary on the second side;
5) for each of the parts of vertical boundaries, determining a number of consecutive smooth samples perpendicular to the potential blocking boundary on both of the first and second sides;
6) for each of the parts of vertical boundaries, determining a width and a height of a current transform block and a width and a height of a neighboring transform block;
7) counting the number of the parts that satisfy the determinations in 3) through 6); and
8) determining the input length and the output length for deblocking filtering of the first side and determining the input length and the output length for deblocking filtering of the second side based on 3) through 7),
wherein the deblocking filtering is performed using the input lengths and the output lengths that are determined.

18. The method of claim 1, wherein the deblocking filtering of the sample values on the at least one of the first side and the second side of the potential blocking boundary, comprises:
linearly interpolating from a virtual sample value on one side of the potential blocking boundary toward another virtual sample value that is centered in a middle of the potential blocking boundary along a line of sample values perpendicular to the potential blocking boundary.

19. The method of claim 1, wherein the input length and the output length for deblocking filtering are determined based on a number of consecutive sample values from the sample value closest to the potential blocking boundary to another sample value closest to a closest neighboring potential blocking boundary, wherein the input length is determined to be 8 and the output length is determined to be 7, and wherein deblocking filtering comprises linearly interpolating from a virtual sample value on one side of the potential blocking boundary (refQ, refP) towards a virtual sample value centered in the middle of the potential blocking boundary (refMiddle) along a line of sample values perpendicular to the potential blocking boundary.

20. The method of claim 1, wherein deblocking filtering of one sample along the line of samples is operated according to:
p′(x)=Clip3(p(x)−tc, p(x)+tc, (f(x)*refMiddle+(64−f(x))*refP+32)>>6; and/or
q′(x)=Clip3(q(x)−tc, q(x)+tc, (f(x)*refMiddle+(64−f(x))*refQ+32)>>6;
wherein x ranges from 0 to 6, p(0) is the sample value closest to the potential blocking boundary in a block P, and q(0) is the sample value closest to the potential blocking boundary in a block Q for the line of samples.

21. The method of claim 1, wherein one of the plurality of blocks and/or a neighboring block uses, as a sub-block coding mode:
frame rate up-conversion, FRUC;
AFFINE;
Alternative temporal motion vector prediction, ATMVP; and/or
Spatial-temporal motion vector predictor, STMVP.

22. The method of claim 1, wherein the potential blocking boundary corresponds to a discontinuity between sample values along a boundary of a first block and sample values along a boundary of a second block, wherein the deblocking filtering is performed to deblock the potential blocking boundary.

23. The method of claim 1, wherein a potential blocking boundary can be identified as a boundary when at least one of the following characteristics is satisfied:
at least one side of the potential blocking boundary is intra predicted;
a difference exists between prediction parameters on each respective side of the potential blocking boundary, wherein prediction parameters comprise at least one of a motion vector, a reference picture, a local illumination compensation, LIC, parameter, a weighted prediction parameter, scaling, and/or an offset in motion-compensated prediction;
a difference exists between residual parameters on each respective side of the potential blocking boundary, wherein a difference in residual parameters comprises one side of the potential blocking boundary belonging to one transform block and another side of the potential blocking boundary belonging to another transform block, wherein at least the one of the sides has non-zero residual parameters; and/or
the potential blocking boundary is a boundary of a transform block and/or a prediction block.

24. The method of claim 1, wherein the input length and the output length for deblocking filtering are determined based on a number of consecutive sample values from the sample value closest to the potential blocking boundary to another sample value closest to a closest neighboring potential blocking boundary, wherein the input length is set to 2 sample values and the output length is set to 1 sample value when the number of consecutive sample values is 4.

25. The method of claim 1, wherein a high efficiency video coding, HEVC, weak deblocking filter is used to deblock at least one sample.

26. An electronic device comprising:
a processor configured to perform operations according to claim 1.

27. An electronic device configured to perform operations comprising:
determining an input length and an output length for deblocking filtering of the sample values on respectively a first side and a second side of a potential blocking boundary, wherein the input length and the output length can be different and are a number of consecutive sample values from a sample value that is closest to the potential blocking boundary to one or more other sample values spaced from the potential blocking boundary, and wherein the input length and the output length are determined based on a number of consecutive sample values from the sample value closest to the potential blocking boundary to another sample value closest to a neighboring potential blocking boundary; and
performing deblocking filtering of the sample values on the at least one of the first side and the second side of the potential blocking boundary, using the input length and the output length that are determined, to generate deblocked sample values.
